(19) United States
(12) Patent Application Publication
(10) Pub. No.: US 2002/0150499 A1
(43) Pub. Date: Oct. 17, 2002

(54) Oil-soluble scale inhibitors with formulation for improved environmental classification

(76) Inventors: James M. Reizer, (US); Michael G. Rudel, (US); Curtis D. Sitz, (US); Rex M. S. Wat, (US); Harry Montgomerie, (US); Andrew Frederick Miles, (US)

Correspondence Address: Browning Bushman P.C., Suite 1800, 5718 Westmeimer, Houston, TX, 77057, US

(21) Appl. No.: 10/055,048

(22) Filed: Jan. 23, 2002

Related U.S. Application Data
(63) Continuation-in-part of application No. 09/361,468, filed on Jul. 27, 1999, now Pat. No. 6,379,612.
(60) Provisional application No. 60/332,147, filed on Nov. 22, 2001.

(51) Int. Cl. C23F 11/00; C23F 11/04; C23F 11/16; A47B 43/00; B01J 19/30; B01J 19/32

(52) U.S. Cl. 422/12; 422/15; 166/279; 422/310

(57) ABSTRACT

The present invention provides compositions of oil-soluble inhibitors suitable for use in inhibiting scale formation in a hydrocarbon production system, such as in an oil field. The compositions comprise an acid form of a known scale inhibitor and 2-ethylhexylamine and similar amines. These compositions possess advantages over conventional compositions used for inhibiting scale formation in that they are less toxic, more biodegradable, and less likely to invade the fatty tissues of marine life.

### CROSS-REFERENCE TO RELATED APPLICATIONS

This application is a continuation-in-part of application Ser. No. 09/361,468, filed Jul. 27, 1999, and claims the benefits of provisional patent application, U.S. Application No. 60/332,147, filed on Nov. 22, 2001, both incorporated by reference.

### FIELD OF THE INVENTION

The present invention relates to compositions comprising oil-soluble scale inhibitors (OSI) and their use in inhibiting scale formation in hydrocarbon production systems such as oil fields. More particularly, the present invention relates to compositions comprising an improved formulation of an oil-soluble scale inhibitor that is more environmentally acceptable for use in oil wells, is less toxic and more biodegradable than other oil soluble scale inhibitors.

### BACKGROUND OF THE INVENTION

The compositions of the present invention can be used in subsurface methods of inhibiting scale formation and deposition in hydrocarbon production systems such as oil fields. Such methods have many advantages over conventional techniques of inhibiting scale, such as decreasing the period for which production of hydrocarbon is suspended or reduced during a formation squeeze treatment and lowering the expense of the descaling operation. Furthermore, the compositions can be used in conjunction with other agents such as anti-corrosion agents, emulsion breakers, wax inhibitors and asphaltene inhibitors.

When a wellbore is initially drilled in an oil field, the oil extracted is usually “dry”, being substantially free of aqueous impurities. However, as the oil reserves dwindle, a progressively greater quantity of aqueous impurities becomes mixed with the oil. Changes in physical conditions during the production cycle as well as mixing of incompatible waters (i.e. seawater and barium or strontium containing formation waters) can cause scaling in any part of the production system. Scale that occurs in the production system can result in a significant loss in production and associated revenue.

One problem with scale formation in large industrial wells is the formation of scale on the equipment used to extract oil from the field, particularly at the perforations and in the production tubing. Near the surface, the sub-surface safety valve is also susceptible to damage caused by scale deposits.

There are several conventional techniques to counter the problem of oil field scale formation, many of which bear significant disadvantages. The technique of “downhole squeezing” is commonly used, wherein inhibitor chemicals in aqueous solution are injected into the near-wellbore area. A typical squeeze in a vertical well will comprise a preflush, a squeeze pill and an overflush treatment. The preflush, typically comprising a mixture of surfactant/demulsifier solution, stops the occurrence of emulsions that would block the perforation pores and often water-wets the formation rock surface. The squeeze pill itself typically involves injection of inhibitor as a 1-20% solution in water, causing saturation of the matrix in a radial area around the well. The overflush displaces the squeeze pill that moves the chemical front to a greater circumference around the wellbore so that a larger surface area of rock matrix is exposed to the inhibitor compound.

When the well is produced, about 30% of inhibitor chemical often returns to the surface immediately. The inhibitor remaining in the well has adsorbed to the rock surface and acts to inhibit scale formation by constant treatment as fluid passes through the rock into the well conduit. However, over time the inhibitor is gradually washed from the rock surface as oil production continues until a further descaling treatment is required.

Various techniques have been used to try to increase the proportion of chemical that adsorbs to the rock. For example, the chemical can be “shut in” for a period of time with the expectation that the greater period of exposure to the rock surface might increase the degree of absorbency of inhibitor. However, this leads to an increase in the time for which a well is not in production and additionally is not considered to be particularly effective.

A further problem with downhole squeezing is that the aqueous solutions of scale inhibitor tend to alter the relative permeability of the rock; due to its immiscibility with water, oil will not easily flow through “water-wet” rock. Once wet, the relative permeability of the rock has been changed, sometimes permanently, so that a water channel can eventually open up into a water pocket, leading to the so-called “water coning” effect wherein a well is irreversibly damaged. Such a well will never again return to fall hydrocarbon productivity and new bores need therefore be sunk in order to economically extract oil from the field.

Another problem with conventional techniques of treatment derives from the fact that aqueous solutions are usually more dense than the crude oil in the field. Consequently, once an aqueous solution of scale inhibitor has been used to treat a well, there can be insufficient pressure support in the field for the well to flow naturally after treatment has finished. Consequently, the well must often be “gas-lifted” back into production using coil tubing until the natural oil pressure is sufficient to drive the flow once again. However, the gas lift facilities may not always be available and it is expensive and time-consuming to rig up temporary facilities.

If continuous injection facilities are available, the inhibitor compound can be applied continuously to the production stream. However, such facilities are not always feasible and are only available in relatively modern wells.

It is only now, with the advent of more advanced techniques for analyzing the process of oil extraction that the problems set out above have been appreciated. There thus exists a need for a method of inhibiting oil scale formation that does not suffer from the disadvantages that beset conventional techniques.

Furthermore, in offshore natural gas production systems, alcohols such as methanol or ethylene glycol are often introduced into the well, wellhead or flowline to prevent formation of hydrates, which can cause plugging problems in the same manner as scale deposition. When gas/condensate production occurs remotely from a platform via a sub-sea flowline, conventionally, chemical injection at the wellhead or downhole is supplied by an umbilical connector in which are contained a bundle of lines. It is necessary to supply scale inhibitor in a separate line because traditional scale inhibitors are generally intolerant of alcohols, to the extent that mixing of the two types of chemicals causes severe precipitation problems with the scale inhibitor. However, each line is extremely costly. Accordingly, a scale inhibitor composition that is compatible with both traditional oilfield treatment chemicals and other organic solvent packages would be particularly useful, since it would remove the necessity to supply the scale inhibitor separately.

Scale inhibitors (SI's) have been used successfully in the applications described above, however a need still exists for scale inhibitor compositions that are more environmentally friendly. This is particularly true in areas that are environmentally sensitive, such as the North Sea.

### SUMMARY OF THE INVENTION

According to a first aspect of the present invention there is provided a composition containing an oil-soluble scale inhibitor, said oil-soluble inhibitor comprising a scale inhibitor and an alkyl primary amine. Preferably, the composition is dissolved in a hydrocarbon or other organic fluid. The alkyl primary amine can be a primary alkyl primary amine, a secondary alkyl primary amine, a tertiary alkyl primary amine, or any combination thereof.

By oil-soluble is meant that the composition is infinitely soluble in usual hydrocarbon carriers such as diesel and kerosene. However, since scale formation in oil wells is only associated with the production of water in the well, it is essential that the scale inhibitor must be able to partition between phases so that it is water soluble in the process system or downhole and therein able to act as an inhibitor of scale formation.

Any inhibitor for which an acid form can be easily produced is suitable for use according to the present invention. Preferably, the acid form of scale inhibitor has a pH of typically less than 2.5. Scale inhibitors suitable for use in accordance with the present environmentally friendly invention include, but are not limited to, phosphonic acids, such as diethylenetriaminepentamethylene phosphonic acid, and bis-hexamethylenetriaminepentamethylene phosphonic acid, acrylic co/ter-polymers, polyacrylic acid (paa), phosphinopolycarboxylic acid (ppca), phosphate esters or other traditional aqueous-based scale inhibitor chemistries. Suitable scale inhibitors will be known to those of skill in the art. Scale inhibitors for the older formulations of the oil-soluble scale inhibitor include, but are not limited to, phosphonates, acrylic co/ter-polymers, polyacrylic acid (PAA), phosphino poly carboxylic acid (PPCA), phosphate esters, or other traditional aqueous-based scale inhibitor chemistries.

In order to form a composition according to the present invention, the scale inhibitor in acid form is blended with an amine to form an oil-soluble mix. The scale inhibitor should be mixed with an alkyl primary amine, such as, for example, the secondary alkyl primary amine such as 2-ethylhexyl amine (2-EHA), the tertiary alkyl primary amines marketed in the Primene® range of compounds (Rohm and Haas), or a combination of the two. A primary alkyl primary amine can also be used alone or in combination with the secondary alkyl primary amine and tertiary alkyl primary amine. While the use of 2-EHA was not as robust as the use of the Primene® compounds, the 2-EHA has a far better environmental classification, which makes its use more desirable in the environmentally sensitive areas.

Tertiary alkyl primary amines possess several advantageous properties over other types of amines for blending with typical scale inhibitors. These advantages include the manageable reactivity of the nitrogen group that gives the chemist great control over the products generated in any reaction process. Additionally, the amines and derivatives thereof remain fluid over a wide range of temperatures and are soluble in hydrocarbon fluids such as kerosene, diesel and HAN (Heavy Aromatic Naphtha).

The alkyl primary amine can contain six or more carbon atoms. Preferably, the alkyl primary amine is 2-EHA. 2-EHA has a better environmental rating than previously used tertiary alkyl primary amines. However, the tertiary alkyl primary amine can possess one amine group or can possess multiple amino groups. The tertiary alkyl primary amine still worked satisfactorily when used in combination with various other scale inhibitors and solvents. The tertiary alkyl primary amine comprises tertiary alkyl primary amines marketed in the Primene® range of compounds (Rohm and Haas), most preferably the Primene® 81-R range. The latter product comprises a mixture of amines in the C12 to C14 range. A mixture of the alkyl primary amine and the tertiary alkyl primary amine looks promising for use in the more environmentally sensitive areas.

It was envisaged that as and when new “green” amine compounds were developed that they would exhibit low toxicity, be biodegradable or not accumulate in the environment, and that these amine compounds would be suitable for use in the oil-soluble scale inhibitors. All of which have been proven true. 2-EHA is one such amine that has significantly improved the environmental rating of the previously disclosed oil-soluble scale inhibitors in U.S. patent application Ser. No. 09/361,468.

Examples of scale inhibitors that are suitable for use in the compositions of the invention from which the present invention was developed include, but are not limited to: hexamethylene diamine tetrakis (methylene phosphonic acid); diethylene triamine tetra (methylene phosphonic acid); diethylene triamine penta (methylene phosphonic acid) (DETA phosphonate); bis-hexamethylene triamine pentakis (methylene phosphonic acid) (BHMT phosphonate); polyacrylic acid (PAA); phosphino poly carboxylic acid (PPCA); 1-hydroxyethylidene 1,1-diphosphonate (HEDP phosphonate); and polymers of sulfonic acid on a polycarboxylic acid backbone.

Suitable ratios of amine to scale inhibitor are those required to produce a reaction product that is infinitely soluble in non-traditional organic solvents such as those mentioned above. The precise proportions of amine to scale inhibitor used to make the composition will depend on the particular scale inhibitor and finished product requirements, but generally will range between the ratios 5:1 to 1:1, more usually 3:1 for amine to scale inhibitor. The concentration of inhibitor in the reaction product can thus typically range between about 1 wt. % to about 30 wt. %, and more preferably in the range of about 2.5 wt. % to about 5 wt. %. The concentration of inhibitor in the previously claimed oil-soluble scale inhibitors can typically range between 10% and 50% by volume. The ratios for the previous oil-soluble scale inhibitors are in the range of 100:1 to 1:3, more usually 8:1 for amine to scale inhibitor. Particularly suitable ratios are 3:2 Primene® phosphonate, 4:1 Primene® to acrylic polymer for the previous versions of the oil-soluble scale inhibitors.

The below listed compositions are also effective as inhibitors of scale for the previously disclosed oil-soluble scale inhibitors in oil well systems. The proportions are only meant as an approximate estimate and variations around these values will be necessary depending upon the environment of the area for treatment. The proportions of scale inhibitor material for blending with the amine refers to proportions of commercially-sold inhibitor products, not proportions of the active ingredient. Most commercial scale inhibitor bases in the concentrated form typically contain 35-50% active solutions of scale inhibitor molecules.

| Commercial scale inhibitors | SI % | Amine |
|---|---|---|
| ATMP Phosphonate | 40 | 60 |
| DETA (Diethylene triamine tetra) Phosphonate | 40 | 60 |
| BHMT (bishexamethylene triamine pentakis) | 50 | 50 |
| Phosphonate | | |
| MEA Phosphonate | 40 | 60 |
| Phosphino Poly Carboxylic Acid | 20 | 80 |
| Acrylic co-ter-polymer | 20 | 80 |

To facilitate their application into a hydrocarbon production system, the scale inhibitor compositions of the invention can be supplied as a concentrate that can be diluted appropriately on site. This reduces the amount of the composition that needs to be conveyed to the site, thus making the transportation process more convenient.

The compositions can also be supplied as a specific dilution with hydrocarbon solvents, including esters, aromatic hydrocarbons, aliphatic cycloparaffinic hydrocarbons, paraffin hydrocarbons and low aromatic distillates, terpenes, linear and alpha olefins, fatty acids, natural oils, and mixtures thereof containing a specific concentration of oil-soluble inhibitor that has been designed for a specific application. Generally, the solvents were selected to have a flash point greater than 63° C. and a viscosity at 20° C. of less than 5 centipoise. The solvents of the previously disclosed oil-soluble scale inhibitor include HAN, diesel, base oil, kerosene, or condensate. The previous formulations for the oil-soluble scale inhibitor can be further blended into diesel or crude oil for use in the field.

One particular solvent that is very well suited for the environmentally friendly version of this invention is ArivaSol®, which is a carrier fluid produced by Uniqema. ArivaSol® has an excellent environmental rating and is biodegradable. Previous typical solvents such as HAN, diesel, base oil, kerosene, or condensate would work. Kemelix H610, which is a HAN, is the solvent of choice for the older formulations. Kemelix H610 has been used in some of the testing with the new environmentally friendly versions of the oil-soluble scale inhibitor.

Alternatively, the compositions can be supplied in other organic solvents not traditionally used with scale inhibitors as the primary solvent, such as 2-ethyl hexanol, butyl triglycol, isopropanol, triethylene glycol, and 2-butoxyethanol. Methanol and isopropanol are some of the organic solvents that can be used with the previous formulations for the oil-soluble scale inhibitors. Traditional scale inhibitors are generally intolerant of such alcohols, to the extent that they cause severe precipitation problems with the scale inhibitor.

Compositions can also be supplied as ready-made dilutions in solvent for direct use in the field, so that no additional mixing is required on site.

A composition according to the present invention can be dissolved in any hydrocarbon fluid for use in a hydrocarbon production system, preferably an oil field. Preferably, the fluid is an aromatic hydrocarbon solvent such as, for example, hydrocarbon fluids such as kerosene, diesel, base oil, HAN, xylene, toluene, condensate, and crude oils. Additionally, the composition can be dissolved in other organic solvents not conventionally used as the primary solvent for scale inhibitor application, such as 2-ethyl hexanol, butyl triglycol, isopropanol, triethylene glycol, and 2-butoxyethanol.

The scale inhibitor will, of course, need to be present in the composition in a concentration effective for the inhibition of scale formation. The lowest concentration at which the scale inhibitor will be effective is termed its minimum inhibitor concentration (MIC), which varies for different mineral contents of the brine water and various physical states, such as temperature and pressure, in which the brine might exist.

Another advantage provided by the compositions of the present invention is that they can be used in conjunction with hydrocarbon production treatment chemicals not conventionally combined with scale inhibitors due to their incompatibility with said scale inhibitors. These chemicals include organic solvent-based production chemicals such as wax inhibitors, asphaltene dispersants and inhibitors, corrosion inhibitors, hydraulic fluids, scale dissolvers, paraffin solvents and dispersants, pour point depressants and wax fluids, crystal modifiers, demulsifiers, foamers and defoamers, gas hydrate inhibitors, biocides and hydrogen sulfide scavengers. This enables an engineer to administer a number of separate treatments in one batch, so decreasing the disruption to the working of the well and correspondingly making periodic overhaul of the well a more cost effective process.

A particularly suitable wax inhibitor is Champion WM 1230 inhibitor and a particularly suitable asphaltene inhibitor is Champion WM 1130 inhibitor. For wax inhibitor, suitable ratios include between 4:6 to 2:8 oil-soluble inhibitor to wax inhibitor. Asphaltene inhibitor might be included in the following ratio; 2:1:7 of oil-soluble inhibitor to wax inhibitor to asphaltene inhibitor. However, since the oil-soluble inhibitor compositions of the invention are completely oil-soluble, wax and/or asphaltene inhibitor can be included at any concentration above its MIC.

Previously disclosed oil-soluble inhibitors demonstrate a high affinity for heterogeneous rock and are adsorbed effectively. Dependent on the volume of oil that flows from an oil well during the time of operation, the effective period of action can be up to or exceeding eighteen months.

According to a second aspect of the present invention there is provided the use of a composition according to the first aspect of the invention in a hydrocarbon production system. By hydrocarbon system is meant any part of the hydrocarbon production process from the wellbore area (including the rock matrix) to any facility or apparatus that makes delivery to a refinery or refinery process. Included as part of a hydrocarbon production system are surface equipment such as heater treaters, crude oil heaters, separators, manifolds, and flow control valves. Flow systems such as pipelines, whether for bulk transport or as field gathering systems, are also included as suitable targets for treatment. Other equipment suitable for treatment will be clear to the skilled worker.

Oil well systems and natural gas production systems are both included as suitable hydrocarbon production systems in which the compositions of the invention can be applied. Preferably, the composition is used in an oil well system. By oil well system is meant any part of the wellbore area (including the rock matrix) or the drill equipment.

According to a still further aspect of the invention there is provided a method of inhibiting oil scale formation in an oil well comprising injecting into the well an oil-soluble scale inhibitor where the inhibitor comprises a scale inhibitor and an alkyl primary amine. The oil-soluble scale inhibitor for this process is the more environmentally friendly version of the oil soluble scale inhibitor. In another embodiment of the invention, a method of treating a well is also included. This method includes the steps of injecting the oil soluble scale inhibitor into an oil system that has a flow of oil or gas to deliver the inhibitor to water based scale.

It is envisaged that conventional downhole squeeze techniques will be most effective in the method of this aspect of the invention to introduce the compositions into the wellbore environment as a batch treatment, although it is not intended that the method be limited to this technique. For instance, in wells where injection facilities are available, compositions according to the invention can be applied continuously to the production stream along with any other desired oil-soluble compounds such as wax inhibitors, asphaltene inhibitors, emulsion breakers, and/or corrosion inhibitors.

Squeezing will typically involve the application of downward pressure on the well so that for a period of time the flow of oil effectively runs in reverse. A typical squeeze in a vertical well will comprise a preflush of around 50-150 barrels of inhibitor pill followed by injection into the rock matrix around the well bore in a radial area of between 200 and 1500 barrels of overflush fluid. The overflush typically comprises an 8-20 foot squeeze using diesel or any other suitable fluid.

Alternative methods of introduction of the oil-soluble scale inhibitors of the present invention into the near wellbore system include the use of downhole and topside continuous injection, and gas lift treatments.

Various aspects and embodiments of the present invention will now be described in more detail by way of example. It will be appreciated that modification of detail can be made without departing from the scope of the invention.

### BRIEF DESCRIPTION OF THE FIGURES

So that the manner in which the above recited features, advantages, and objects of the present invention are achieved can be understood in detail, more particular description of the invention, briefly summarized above, may be had by reference to the embodiments thereof which are illustrated in the appended drawings.

It is to be noted, however, that the appended drawings are only for illustrative purposes to demonstrate only typical embodiments of the invention and therefore are not to be considered limiting of its scope, for the invention may admit to other equally effective embodiments.

FIG. 1 shows the partition of the previously disclosed oil soluble scale inhibitor (Chem II) at different temperatures.

FIG. 2 shows the partition of the previously disclosed oil soluble inhibitor (OSI) with different initial concentrations.

FIG. 3 shows the MIC of Chem I (water-based) using Brine C at 90° C.

FIG. 4 shows the MIC of Chem I (oil-based) using Brine C at 90° C.

FIG. 5 shows the MIC of Chem II (water-based) using Brine C at 90° C.

FIG. 6 shows the MIC of Chem II (oil-based) using Brine C at 90° C.

FIG. 7 shows the MIC of Chem III (water-based) using Brine C at 90° C.

FIG. 8 shows the MIC of Chem III (oil-based) using Brine C at 90° C.

FIG. 9 is a diagrammatic illustration of injectivity tests performed at 90° C.

FIG. 10 shows the increase in pressure as oil is introduced at the inlet face in an injectivity test.

FIG. 11 shows the rate and extent of pressure changes as oil is introduced into the matrix.

FIG. 12 shows the pressure change as the core is cleaned with IPA.

FIG. 13 shows the pressure response during the final cycle of injection involving the oil-soluble inhibitor.

FIG. 14 shows the ambient temperature kerosene flood.

FIG. 15 shows detail of the ambient temperature decreasing rate permeability measurement to kerosene.

FIG. 16 shows the crude oil flood and measurement of effective permeability to crude oil [ko,eff(II)] at 125° C.

FIG. 17 shows detail of the measurement of effective permeability to crude oil [ko,eff (II)].

FIG. 18 shows the ΔP for each of the OSi injection stages.

FIG. 19 shows the core ΔP for each stage of the simulated chemical return. No significant changes in ΔP are observed for any stage.

FIG. 20 shows the return crude oil flood and final oil permeability (ko,eff (III)). The data show a quick return to a stable flowing ΔP with no apparent problems.

FIG. 21 shows detail of the measurement of ko,eff (III). The data presented in this figure were used to calculate the final effective permeability to oil of 443 mD.

FIG. 22 shows a plot of the scale inhibitor return concentration versus approximate PV injected.

FIGS. A1 through A9 show digital images of samples collected during core flood studies.

### EXAMPLES

In the below examples, all references to tertiary alkyl primary amine refer to the Primene® 81R product sold by Rohm & Haas. All references to primary alkyl primary amine refer to 2-EHA. OSI: oil soluble inhibitor.

All references to Chem I, Chem II and Chem III relate to compositions containing defined components in specific ratios as described in the below Table 1. The percentage of scale inhibitor solution is also given for clarity. The compositions in Table 1 are for the previously disclosed oil soluble scale inhibitor and not for the improved environmentally friendly version.

Scale inhibitor SA990 is sold by Champion Technologies. DETA phosphonate is diethylene triamine tetra (methylene phosphonic acid); BHMT phosphonate is bis-hexamethylene triamine pentakis (methylene phosphonic acid).

TABLE 1

| | Amine | | | Scale inhibitor |
|---|---|---|---|---|
| Chem | (Primene ®) | Phosphonate | HAN | solution % |
| I | 3 | 2 (product SA990) | 15 | 10 |
| II | 3 | 2(DETA phosphonate) | 5 | 20 |
| III | 3 | 3(BHMTphosphonate) | 6 | 25 |

Experiments are shown below that demonstrate that compositions according to the present invention behave like a “normal” scale inhibitor in preventing scale formation when partitioned into the aqueous phase.

### Example 1

### Partitioning Mechanisms for Chem I

Like the other mass transfer processes, the partition kinetics of the oil soluble scale inhibitor among the different phases will depend on a number of factors, such as the scale inhibitor type, the mixing regime, temperature, concentration gradient, contact time, brine composition and the type of hydrocarbon fluid.

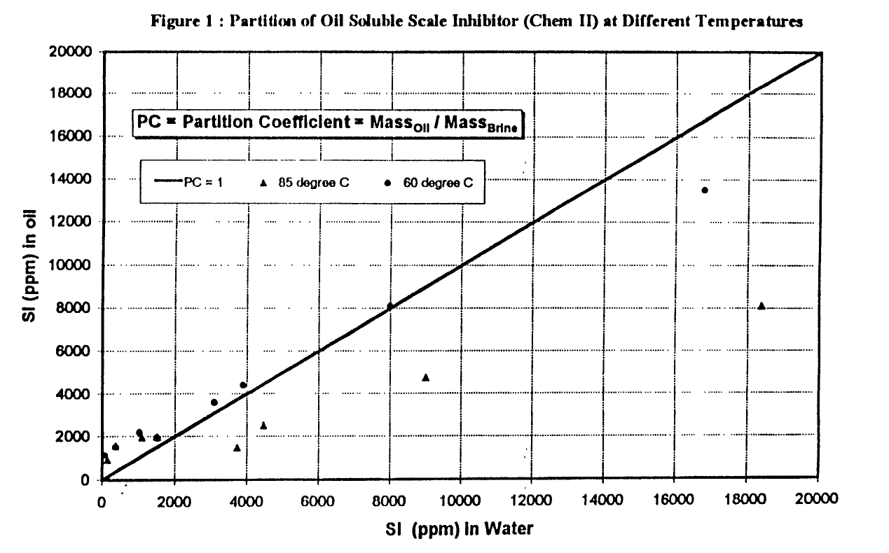

The effect of temperature on the partition process is illustrated in FIG. 1. In this test a duplicate set of 8 oil soluble scale inhibitor samples, of various concentrations (1,400 ppm to 70,000 ppm), were mixed with Brine D (Table 2). The oil to brine ratio was kept at 1:3.4. One set of samples was heated to 60° C. while a duplicated set was heated to 85° C. The samples were shaken regularly and after overnight lock-in at temperature the aqueous portions were drained off and analyzed for scale inhibitor concentration. It is clear from FIG. 1 that the amount of scale inhibitor partitioned in the water increased with temperature.

TABLE 2
Brine Compositions used for OSI Tests

| | Brine A | Brine B | Brine C | Brine D |
|---|---|---|---|---|
| PH | 5 | 6 | 5.5 | 8 |
| Ca++ | 1,400 ppm | 650 ppm | 12,000 ppm | 260 ppm |
| HCO3− | N/A | N/A | 500 ppm | 650 ppm |
| TDS | 40,000 ppm | 35,000 ppm | 135,000 ppm | 4,000 ppm |

[TDS: Total dissolved solids]

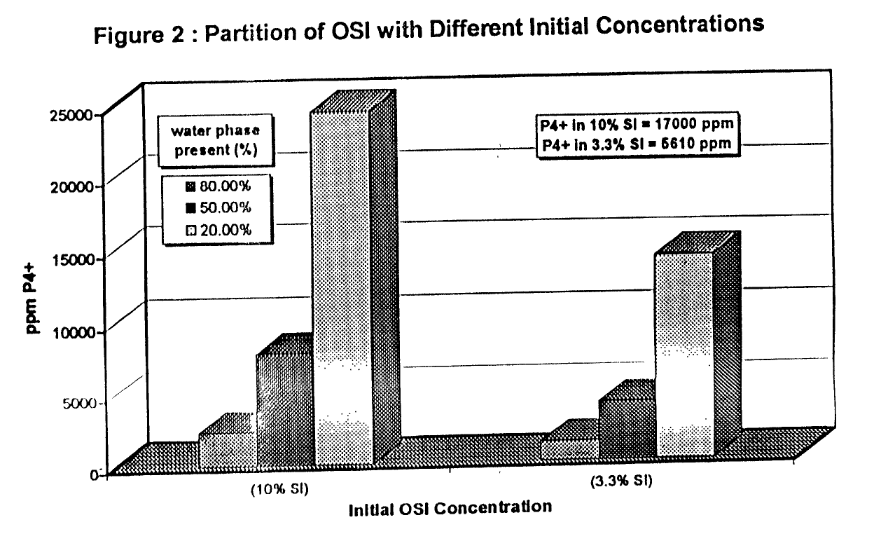

The effect of concentration gradient on the partition process can be illustrated by FIG. 2. In this test a 10% and a 3.3% oil-soluble scale inhibitor solutions were prepared. These were mixed with Brine A (Table 2) at three different oil: brine ratios, i.e. 1:4, 1:1, and 4:1. The six samples were shaken vigorously before being placed in an oven overnight at 120° C. The brine portions were withdrawn and analyzed for the scale inhibitor concentration in the following day. The results in FIG. 2 confirm that the partitioning of scale inhibitor in the water phase increases with the initial oil-soluble inhibitor concentration.

Indeed, for the sample with an oil to brine ratio of 4:1, the equilibrium concentration in the brine was found to be significantly higher than that in the original OSI sample, i.e. 24,560 ppm vs. 17,000 ppm for the 10% solution and 14,280 ppm vs. 5,610 ppm for the 3.3% solution. This enhanced mass transfer process, with a partition coefficient (defined as Massoil phase/Masswater phase) greater than one, indicates that a better chemical utilization can be achieved in the field. For squeeze treatment, this means that an OSI pill with a lower concentration than that in a normal water based pill can achieve a similar adsorption efficiency.

The results in FIGS. 1 & 2 confirm that the oil soluble scale inhibitor will partition into the water phase. The rate and the amount of mass transfer can be increased with temperature and concentration gradient.

### Example 2

### Scale Inhibitor Function for Chem II

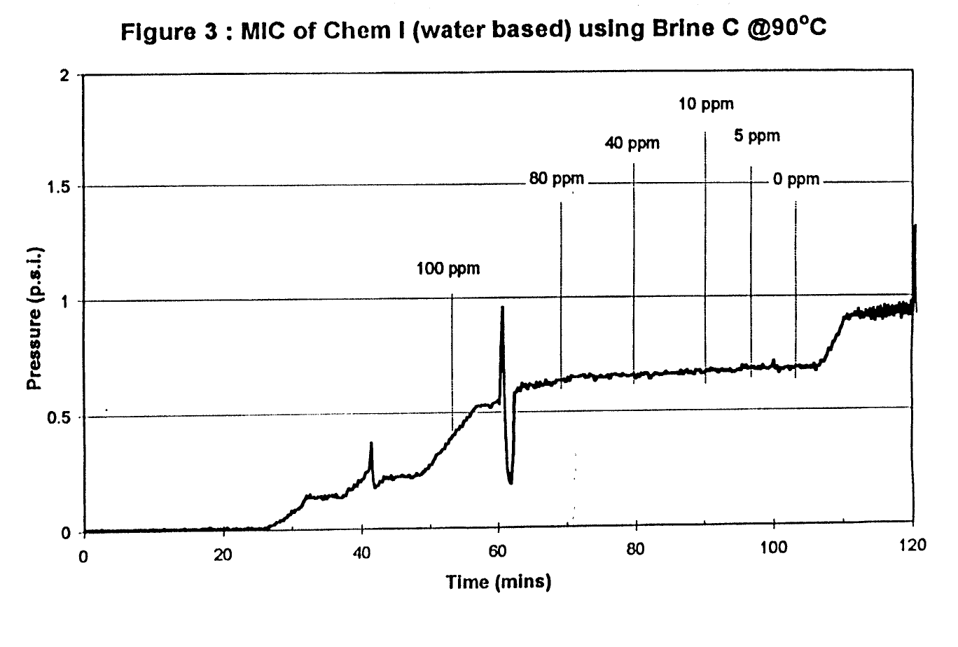

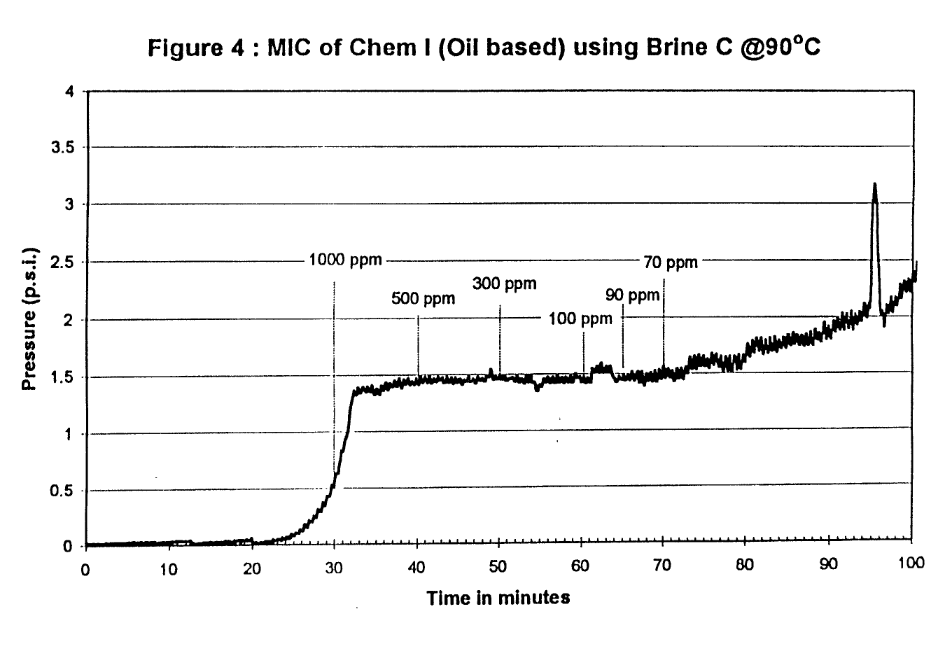

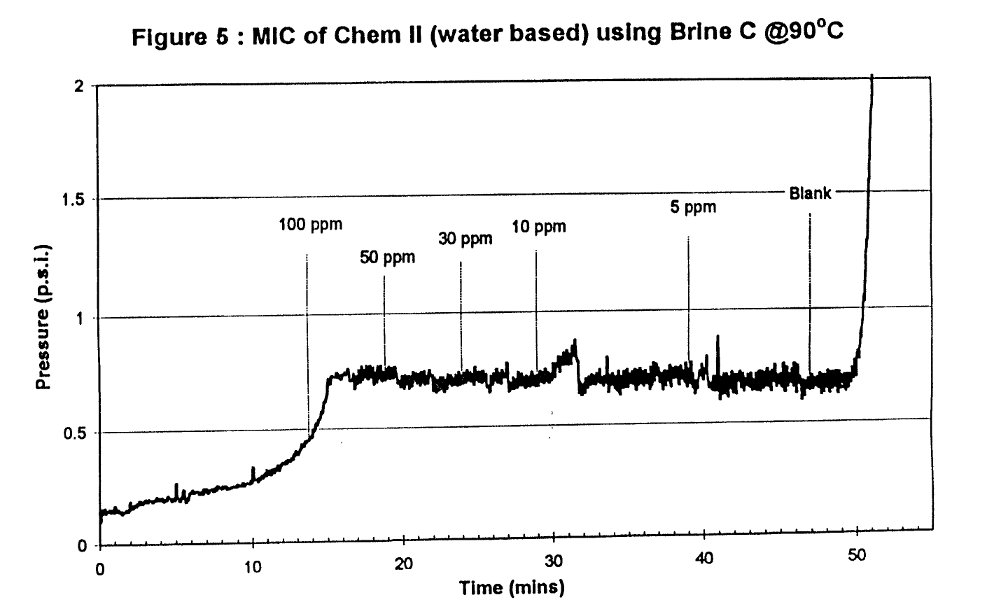

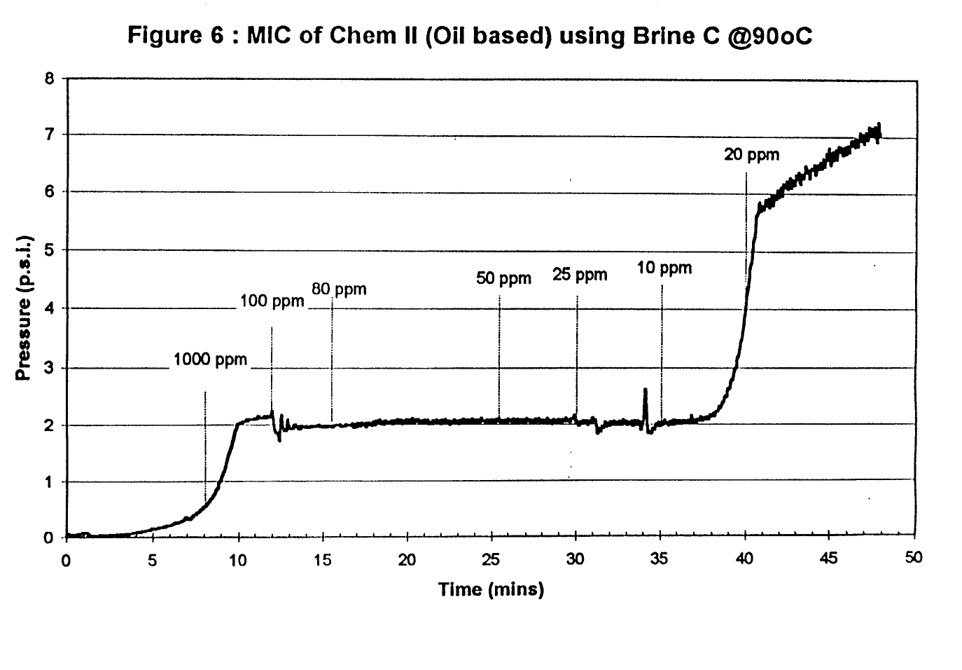

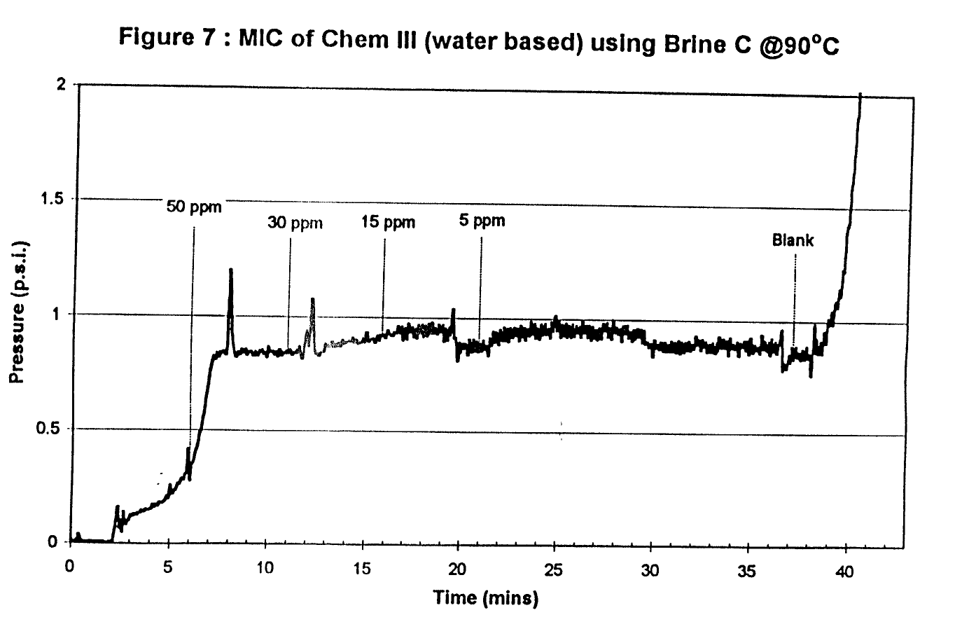

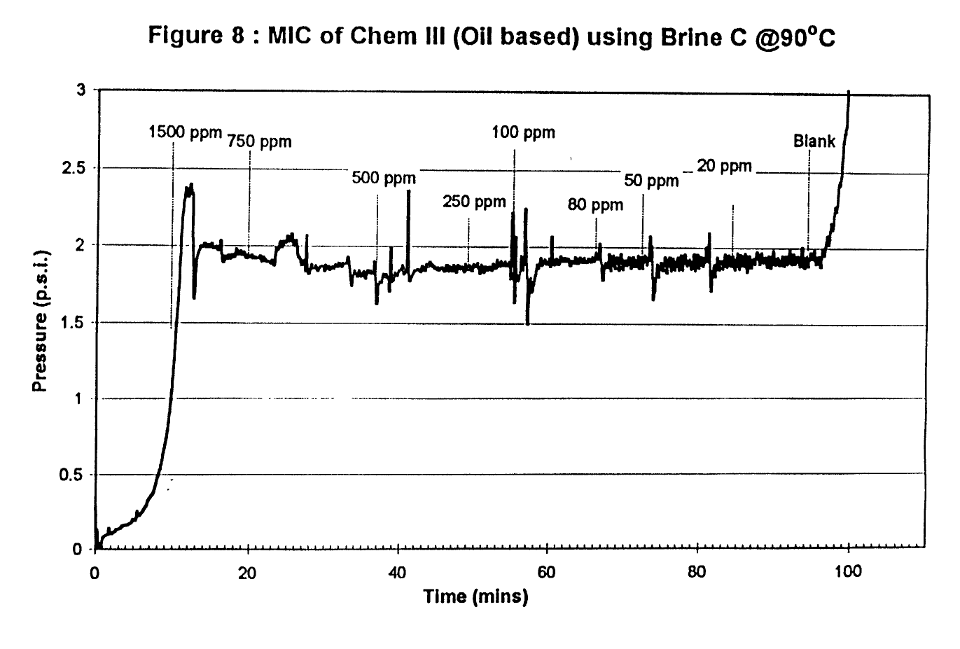

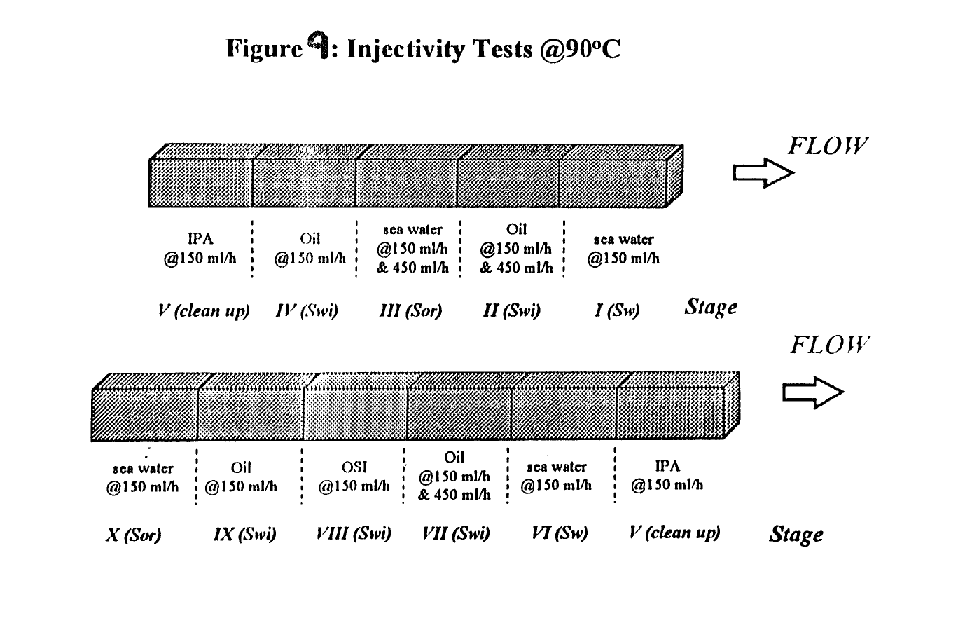

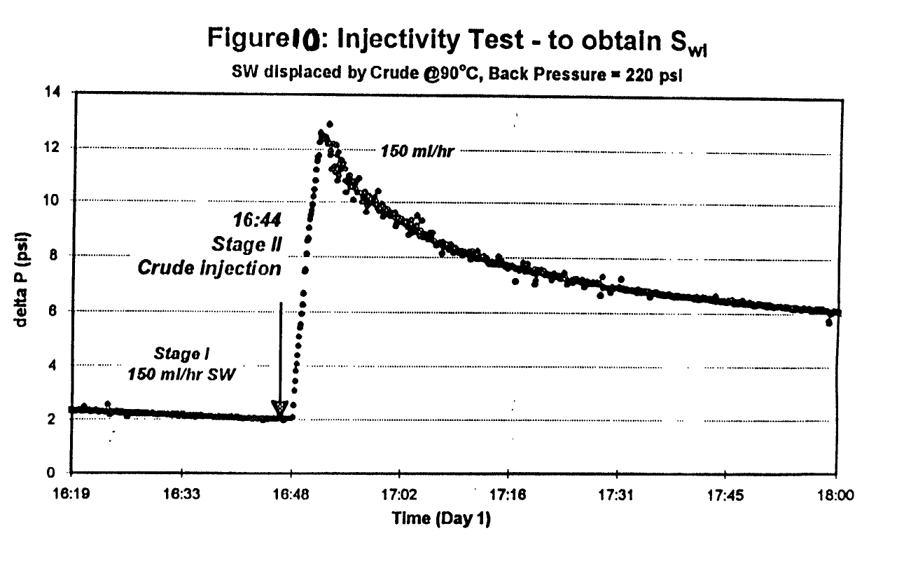

The next crucial question was whether the partitioned molecules behave like a “normal” scale inhibitor in preventing scale formation. FIGS. 3 to 8 show the results of dynamic tube blocking tests using Chem II diluted 50:50 with either HAN or base oil.

The dynamic tube blocking test is one of the standard procedures in checking scale inhibitor performance. If the inhibitor product is working and the dose rate is adequate it will stop scale deposit in the coil (tubing of 1/16″ to ⅛″ OD), which in turn will not cause pressure build-up. After first allowing the coil to prescale, causing an initial rise in pressure, the system is dosed with a known scale inhibitor concentration (normally in excess). The pressure will level off as deposition is stopped. The dose rate is then stepped back until the pressure shows sign of rising again. The minimum inhibitor concentration (MIC) of the product is thus defined. Obviously the MIC value will vary with the type of brine (severity of scale) and the test temperature.

The tests were carried out at 90° C. using Brine C (Table 2). The activity of the scale inhibitor used, both in the oil and water form, is shown in Table 3. It is clear from the pressure profiles and from Table 3 that the oil soluble scale inhibitor, once partitioned in the water, will inhibit scaling. More importantly, the partitioned molecules offer the same level of MIC as with the water-based product. The short residence time of the tube blocking test indicates that the partitioning process must be fast enough to enable the water bound scale inhibitor to function.

TABLE 3
MIC's of scale inhibitor from Dynamic Tests

| | MIC | | Ref. |
|---|---|---|---|
| Chem I(100% in water) | <5 | ppm | |
| Chem I(10% in oil) | 70-90 | ppm | |
| Chem II(100% in water) | <5 | ppm | |
| Chem II(20% in oil) | 10-25 | ppm | |
| Chem III (100% in water) | <5 | ppm | |
| Chem III (25% in oil) | <20 | ppm | |

### Example 3

### Multi-Stage Contact for Previously Disclosed Oil Soluble Scale Inhibitor

Apart from inhibition performance, an oil soluble scale inhibitor must exhibit desorption characteristics similar to a water-based product in order to be considered for squeeze treatment.

It could be stated that the tests described above resemble only a single stage contact in the partition process and therefore that these results do not fully reflect the full mechanisms that will take place in real life. For example, in field applications, the oil-soluble scale inhibitor is likely to be in continuous contact with fresh brine, e.g. at the chemical front during a squeeze treatment. While most of the inhibitor molecules will partition into the water phase on their first contact, some of them will remain in the oil phase.

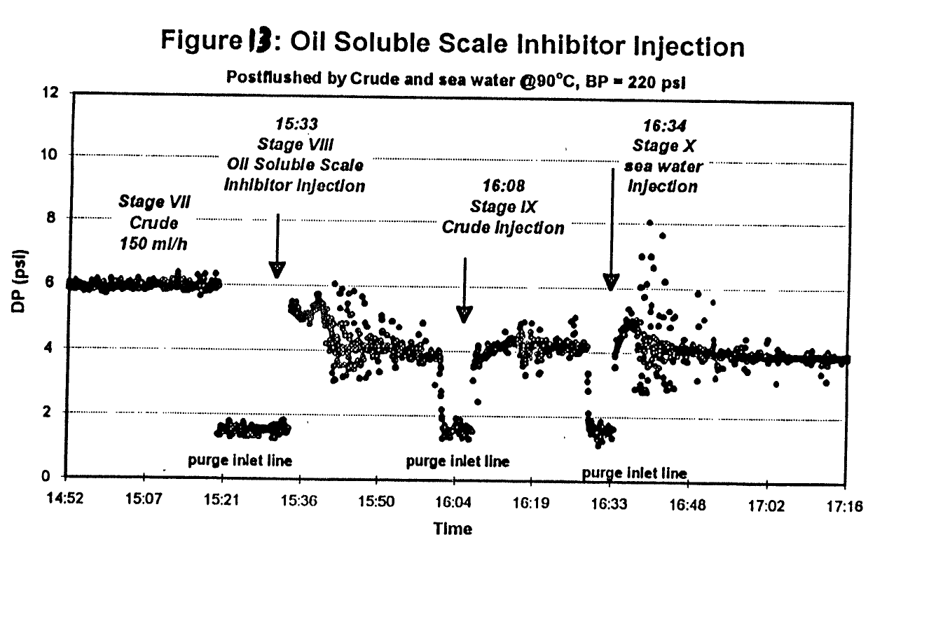

In order to assess what would happen to inhibitor molecules remaining in the oil phase after the initial contact with aqueous phase and a multi-stage contact, a test was performed in which the oil soluble scale inhibitor was repeatedly mixed with fresh brine. The results are present in FIG. 10.

In this test we used an oil:brine (Brine B) ratio of 9:1. The initial oil soluble scale inhibitor concentration was 10% (17,000 ppm of P4+). The test was carried out at 80° C. The sample was shaken regularly and a known fraction of the brine was withdrawn at an hourly interval. After each withdrawal fresh brine was added to the mix so as to maintain the oil:brine ratio at 9:1. The water samples collected were analyzed for the scale inhibitor concentration.

The results clearly illustrate the trend of recovering the oil soluble scale inhibitor through a multi-stage “washing” process. There was scale inhibitor partitioned in each stage with the highest return in the first contact. The cumulative amount of scale inhibitor recovered during the 9 stages was estimated to be 30% of the original mass with the first stage recovering approximately 10% of the total. The partition rate was believed to be very fast in this test.

The partitioning efficiency of the OSI observed in the beaker tests, including the cumulative recovery from the multi-stage contact, is likely to be conservative for squeeze treatment consideration. This is because in the presence of a solid phase (e.g. a sand grain) there will be an additional mass transfer process adsorption onto the solid surface. The scale inhibitor molecules, once partitioned into the water phase, will be free to migrate towards the grain surface. If there are adsorption sites available the molecules will bind to the surface. This effectively maintains a concentration gradient between the oil and the water and is continuously driving the partitioning process until the available solid phase adsorption sites have been occupied.

It is therefore feasible that, for the same generic type of scale inhibitor, the utilization of the chemical can be more efficient if it is oil soluble. Through the partitioning mechanisms described earlier, the scale inhibitor concentration in the aqueous phase can be driven higher than that in the original oil phase. A lower concentration pill could be used for the oil soluble product and still achieve the same adsorption level as a water-based product, which could also mean less wastage of chemical in the initial squeeze return.

### Example 4

### Injectivity Tests for Previously Disclosed Oil Soluble Scale Inhibitor

One of the main benefits of squeezing an oil soluble scale inhibitor into a dry or low water cut well is to avoid the injection and back flow problems caused by water ingress. We provide herein a direct comparative study in quantifying the effect of relative permeability on the flow of different phases in a porous medium.

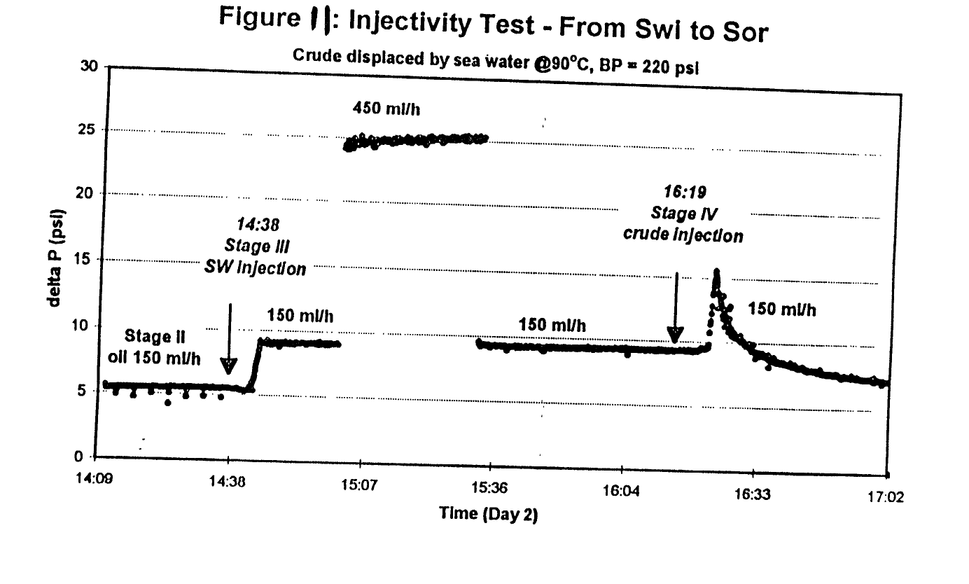

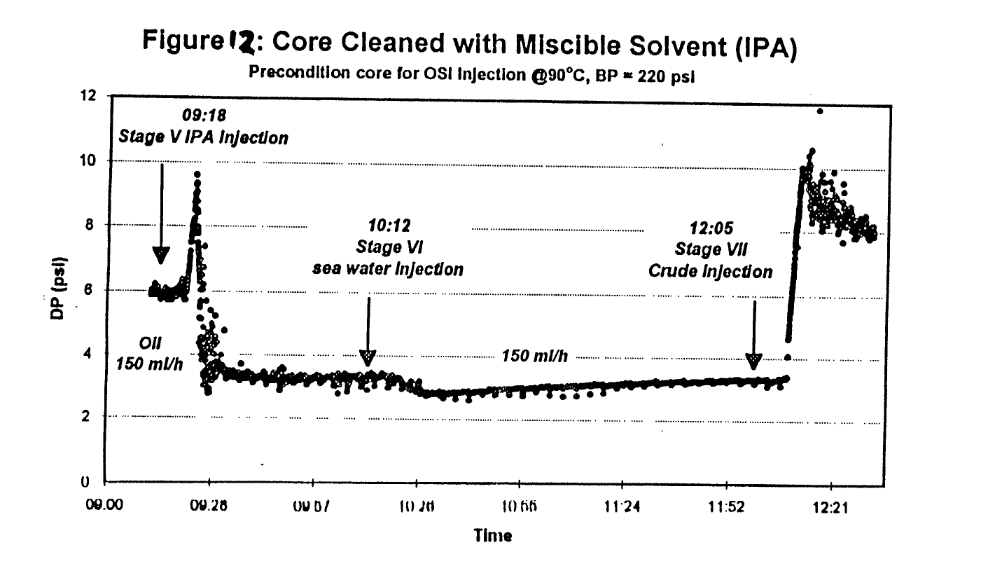

In the course of developing the new OSI products, we have carried out a series of injectivity tests. The tests consist of 10 different stages and these can be grouped into two distinctive cycles as shown in FIG. 9.

The first cycle of injections (stage I to V) was designed to establish the base line pressure profile when either oil or brine was used as the displacing fluid. In these tests the differential pressure (ΔP) profiles represented the transient and the end points of an immiscible displacement process. They indicated the necessary pressure increase in placing and the subsequent backflowing of an immiscible fluid. Using the same core sample the second cycle of injection was intended to highlight the differences in the pressure response of a miscible displacement process.

In the second cycle we used the isopropyl alcohol (IPA) as the solvent since it was miscible with both the oil and the brine. The main step was stage VIII when we used an oil soluble scale inhibitor to displace the crude. This provided a comparison with stage III in which the brine displaced the oil.

The conditions of the injectivity tests are summarized below.

| | |
|---|---|
| Test Conditions | |
| Temperature | 90° C. |
| Overburden Pressure | 2000 psi |
| Back Pressure | 220 psi |
| Nominal Flow Rate | 150 ml/hr |
| Core Properties | |
| Material | Clashach sandstone |
| Permeability | 533 mD |
| Porosity | ˜18% |
| Dimensions | 2.5 cm dia × 15 cm L |
| Sor | ˜35% |
| Swi | not measured |
| Fluid System | |
| Brine | seawater (without HCO3-) |
| Oil | ˜38o API crude (stabilized) |
| SI | Oil Soluble Scale Inhibitor (OSI) |
| Solvent | IPA (core cleaning/conditioning) |

In stage I, the core was first saturated with seawater and the permeability was determined. This was followed by the injection of the crude oil (stage II). The sharp increase in the differential pressure (ΔP) across the core, as shown in FIG. 10, represented the arrival of the oil at the inlet face. After peaking at ˜13 psi the ΔP decreased gradually as most of the brine had been displaced by the crude. The nearly six times increase in the ΔP, i.e. from 2 to ˜13 psi, was significant. This was mainly due to the Clashach core being water wet and that the core was initially saturated with brine. For reservoir rock materials the increase in ΔP might be less noticeable due to their mixed wettability. In the field the hydrostatic head exerted by the water column in the well also helps to mask such increase in the injection pressure. Indeed in some cases, it has been noticed that there is a negative injection pressure (i.e. suction mode) once a certain volume of seawater has been pumped into the well.

Stage III, brine injection, and stage IV, crude injection, were to condition the core to the residual oil saturation (Sor) and the irreducible water saturation (Swi) respectively. The pressure profile recorded during this period, as shown in FIG. 11, resembles the pressure increase when a water based SI pill is being squeezed into a dry oil zone. In the field, while one can maintain the injection rate so long as it stays below the fracture pressure, the back flow is less controllable. How easily and how fast the well re-flows will depend on the available pressure support. For a well with weak lifting energy, there can be a big reduction in the total production rate. This will continue until the near wellbore area is cleaned up from the extensive water ingress associated with the squeeze treatment. It is important to realize that the shape, the rate and the extent of the pressure rise, as observed in FIGS. 10 to 13, are strongly dependent on the matrix and fluid properties, i.e. wettability, pore connectivity, pore size and fluid viscosity, and so on.

At the end of stage IV, isopropyl alcohol (IPA) was injected into the core. The use of IPA had two objectives. First, it was used to clean the core so that a 100% brine saturation could be re-established and the remaining flood cycle commenced. Second, since the IPA was miscible with both the brine and crude it would provide a reference pressure profile when the OSI was used to displace the oil at a later stage.

The pressure recorded during this period is presented in FIG. 12, which shows a surprise peak at the start. The initial spike was caused by the propagation of the oil and water “banks” since IPA was used as the displacing fluid. Although the IPA was miscible with both the crude and the brine, complete mixing was only achieved at the displacement front where there was contact. In a one-dimensional flow as in the core test the displacement (miscible) front would push ahead both the oil and water and cause the “banking” of the different fluid. On the other hand, there was almost no change in the ΔP response when the seawater was displacing the IPA in stage VI since the core was 100% saturated with the IPA at this time.

After the core was cleaned and resaturated with brine, crude oil was once again injected to condition the core to Swi (stage VII). The final cycle of injection including the OSI, the crude oil (1 st post flush) and the brine (2nd post flush) then began. The ΔP response during this period was recorded and is presented in FIG. 13. As expected, there was no noticeable rise in the ΔP when the oil soluble scale inhibitor was displacing the crude. Indeed there was a minor drop in the ΔP as the injection of the OSI continued. The drop in ΔP was likely due to a combination of different fluid viscosity and a further reduction in the water saturation. As the OSI started breaking through, a small amount of water (˜1 ml) was observed in the effluent. Although the core had been driven to irreducible water saturation (Swi) previously, the partitioning of the OSI into the connate water seemed to alter the brine properties. Indeed in the compatibility tests that were carried out separately, we had noticed the “poor” interface between the OSI and the brine at equilibrium, i.e. long settling time after samples had been shaken. This indicated that there was a reduction in the interfacial tension. The level of irreducible water saturation (Swi) is strongly affected by the oil/water interfacial tension, fluid viscosity and displacement velocity.

The pressure responses in stage IX and X were as expected. There was little change in the ΔP when the OSI was displaced by the crude oil and vice versa, indicating full miscibility. On the other hand there was a small rise in ΔP when the brine was finally injected to displace the crude.

### Example 5

### Preparation of Previously Disclosed Oil Soluble Scale Inhibitors

An oil soluble scale inhibitor was prepared by mixing an acid DETA phosphonate solution (pH<1) with a tertiary alkyl primary amine (Primene® 81-R; Rohm & Haas) with a ratio of 3 part amine to 2 part of phosphonate. The mixture was shaken vigorously in order to obtain a homogenized solution. There was some air entrained and heat generated due to mixing but the solution cooled and became clear after left standing for a short time. No addition of mutual solvent of any kind was needed. The resulting mix was quite viscous and was diluted in a heavy aromatic naphtha (HAN) to reduce its viscosity. The composition of the mix was as follows:

| Component | Wt % |
|---|---|
| DETA phosphonate solution | 20 |
| Tertiary alkyl primary amine | 30 |
| HAN | 50 |

The scale inhibitor was found to partition back into the water phase when the mixture was in contact with a brine A.

In our tests a 50% and a 16.7% w/w solution of the above mix were prepared using base oil. These were mixed with Brine A at three different oil:brine ratios, i.e. 1:4, 1:1 and 4:1. The six samples were shaken vigorously before being placed in an oven overnight at 120° C. The brine portions were withdrawn and analyzed for the scale inhibitor concentration the following day. The results confirmed that the partitioning of scale inhibitor in the water phase increased with the initial OSI concentration. Indeed, for the sample with an oil to brine ration of 4:1, the equilibrium concentration in the brine was found to be significantly higher than that in the original OSI sample, i.e. 24,560 ppm vs. 17,000 ppm for the 10% solution and 14,280 ppm vs. 5,610 ppm for the 3.3% solution.

Once partitioned in the water the scale inhibitor performed well in inhibiting scale formation. This was confirmed by the dynamic tube blocking tests commonly used for product screening. The tests were carried out at 90° C. using Brine C and, for comparison, a water-based acid IC DETA phosphonate was included (Gyptron® KT-178, Champion Technologies).

The results confirmed that the partitioned molecules offer the same level of MIC as with the water based product.

### Example 6

### Preparation of Previously Disclosed Oil Soluble Scale Inhibitors

An oil soluble scale inhibitor was prepared by mixing an acid BHMT phosphonate solution (pH<1) with a tertiary alkyl primary amine with a ratio of 3 part amine to 3 part of phosphonate. The mixture was shaken vigorously in order to obtain a homogenized solution. There was some air entrained and heat generated due to mixing but the solution cooled and became clear after left standing for a short time. No addition of mutual solvent of any kind was needed. The resulting mix was quite viscous and was diluted in a heavy aromatic naphtha (HAN) to reduce the viscosity. The composition of the mix was:

| Component | Wt % |
|---|---|
| BHMT phosphonate | 25 |
| Tertiary alkyl primary amine | 25 |
| HAN | 50 |

The scale inhibitor was believed to partition back into the water phase later on when the mixture was in contact with a brine. Once partitioned in the water, the scale inhibitor also performed well in inhibiting scale information. This was confirmed by the dynamic tube blocking tests commonly used for product screening. The tests were carried out at 90° C. using a Brine C and, for comparison, a water-based acidic BHMT phosphonate was included (Gyptron® KT-252, Champion Technologies). The results confirmed that the partitioned molecules offer the same level of MIC as with the water-based product.

### Example 7

### Compatibility Tests of Environmentally Friendly Formulations

Compatibility tests were performed on the “green” environmentally friendly formulations of the oil soluble scale inhibitors. The typical procedure used to make the oil soluble scale inhibitors was to add the solvent first, followed by the amine, and then the scale inhibitor (SI). The variables that were investigated were the type of scale inhibitor used, the concentration of the scale inhibitor, the ratio of scale inhibitor to amine, and the temperature. ArivaSol® was the solvent and 2-EHA was the amine used in these tests. The results of the compatibility tests are shown in Tables 4, 5, and 6. Further compatibility tests were performed using a one part 2-EHA to two parts Primene® 81-R mixture as the amine of the oil soluble scale inhibitor. The results are summarized in Table 7. In most of the compatibility tests that were performed for the new environmentally friendly formulations, use of an additive, such as 2-Butoxyethanol (EGMBE) was required in a small amount to make a more stable formulation.

TABLE 4
SI-X, 2-EHA WITH ARIVASOL ® STABILITY TESTS

| | | | | Temperature (° C.) | | | | | | | | |
|---|---|---|---|---|---|---|---|---|---|---|---|---|
| SI (%) | AMINE | Solvent | EGMBE (%) | −20 | −7 | 4 | 20 | 40 | 80 | 100 | 140 | 180 |
| 2.5 | 1:1 SI: 2-EHA | ArivaSol | 2.5 | | | | N | | N | | | |
| 2.5 | 1:2 SI: 2-EHA | ArivaSol | 2.5 | | | | N | | N | | | |
| 2.5 | 1:3 SI: 2-EHA | ArivaSol | 2.5 | | | | N | | Y | | | |
| 2.5 | 1:4 SI: 2-EHA | ArivaSol | 2.5 | N | | N | Y | | Y | | | |
| 2.5 | 1:5 SI: 2-EHA | ArivaSol | 2.5 | N | | N | Y | | Y | | | |
| 5.0 | 1:1 SI: 2-EHA | ArivaSol | 2.5 | | | | N | | N | | | |
| 5.0 | 1:2 SI: 2-EHA | ArivaSol | 2.5 | N | | N | Y | | N | | | |
| 5.0 | 1:3 SI: 2-EHA | ArivaSol | 2.5 | N | | N | Y | | Y | | | |
| 5.0 | 1:4 SI: 2-EHA | ArivaSol | 2.5 | N | | Y | Y | | Y | Y | Y | Y |
| 5.0 | 1:5 SI: 2-EHA | ArivaSol | 2.5 | N | | N | Y | | Y | | | |
| 7.5 | 1:1 SI: 2-EHA | ArivaSol | 2.5 | | | | N | | | | | |
| 7.5 | 1:2 SI: 2-EHA | ArivaSol | 2.5 | | | | N | | | | | |
| 7.5 | 1:3 SI: 2-EHA | ArivaSol | 2.5 | N | | Y | Y | | | | | |
| 7.5 | 1:4 SI: 2-EHA | ArivaSol | 2.5 | N | | Y | Y | | | | | |
| 7.5 | 1:5 SI: 2-EHA | ArivaSol | 2.5 | Y | | Y | Y | | | | | |
| 5.0 | 1:3 S1: 81-R | H610 | 2.5 | Y | | Y | Y | | | | Y | |

TABLE 5
DETA PHOSPHONATE, 2-EHA WITH ARIVASOL ® STABILITY TESTS

| | | | | Temperature (° C.) | | | | | | | |
|---|---|---|---|---|---|---|---|---|---|---|---|
| SI (%) | AMINE | Solvent | EGMBE (%) | −20 | −7 | 4 | 20 | 40 | 80 | 100 | 142 |

| | | | | | | | | | | |
|---|---|---|---|---|---|---|---|---|---|---|
| 2.5 | 1:1 SI: 2-EHA | ArivaSol | 2.5 | Y | Y | Y | | N | | |
| 2.5 | 1:2 SI: 2-EHA | ArivaSol | 2.5 | N | Y | Y | | N | | |
| 2.5 | 1:3 SI: 2-EHA | AnivaSol | 2.5 | N | N | Y | | Y | | |
| 2.5 | 1:4 SI: 2-EHA | ArivaSol | 2.5 | N | N | Y | | Y | | |
| 2.5 | 1:5 SI: 2-EHA | ArivaSol | 2.5 | N | N | Y | | Y | | |
| 5.0 | 1:1 SI: 2-EHA | ArivaSol | 2.5 | Y | Y | Y | | N | | |
| 5.0 | 1:2 SI: 2-EHA | ArivaSol | 2.5 | N | N | Y | | Y | | |
| 5.0 | 1:3 SI: 2-EHA | ArivaSol | 2.5 | N | N | Y | | Y | | |
| 5.0 | 1:4 SI: 2-EHA | ArivaSol | 2.5 | N | N | Y | nm | Y | Y | Y |
| 5.0 | 1:5 SI: 2-EHA | ArivaSol | 2.5 | N | N | Y | | Y | | |
| 5.0 | 1:3 SI: 81-R | H610 | 2.5 | Y | Y | Y | | | | Y |

TABLE 6
BHMT PHOSPHONATE, 2-EHA STABILITY TESTS

| | | | | Temperature (° C.) | | | | | | | |
|---|---|---|---|---|---|---|---|---|---|---|---|
| SI (%) | AMINE | Solvent | EGMBE (%) | −20 | −7 | 4 | 20 | 40 | 80 | 125 | 142 |
| 2.5 | 1:1 SI: 2-EHA | ArivaSol | 2.5 | Y | | Y | Y | | Y | | |
| 2.5 | 1:2 SI: 2-EHA | ArivaSol | 2.5 | N | | Y | Y | | Y | | |
| 2.5 | 1:3 SI: 2-EHA | ArivaSol | 2.5 | N | | Y | Y | | Y | | |
| 2.5 | 1:4 SI: 2-EHA | ArivaSol | 2.5 | N | | N | Y | | Y | | |
| 2.5 | 1:5 SI: 2-EHA | ArivaSol | 2.5 | N | | N | Y | | Y | | |
| 5.0 | 1:1 SI: 2-EHA | ArivaSol | 2.5 | Y | | Y | Y | | Y | Y | Y |
| 5.0 | 1:2 SI: 2-EHA | ArivaSol | 2.5 | Y | | Y | Y | | Y | Y | Y |
| 5.0 | 1:3 SI: 2-EHA | ArivaSol | 2.5 | N | | N | Y | | Y | | |
| 5.0 | 1:4 SI: 2-EHA | ArivaSol | 2.5 | N | | N | Y | | Y | | |
| 5.0 | 1:5 SI: 2-EHA | ArivaSol | 2.5 | N | | N | Y | | Y | | |
| 5.0 | 1:3 SI: 81-R | ArivaSol | 2.5 | YY | | Y | Y | | | | |
| 5.0 | 1:3 SI: 81-R | H610 | 2.5 | Y | | Y | Y | | | | Y |
| 5.0 | 1:3 SI: 2-EHA | H610 | 2.5 | N | | Y | Y | | | | |

TABLE 7
PRODUCT STABILITY TESTS

| | | | | Temperature (° C.) | | | | | | |
|---|---|---|---|---|---|---|---|---|---|---|
| Formulation | Description | Solvent | EGMBE (%) | −20 | −7 | 4 | 20 | 88 | 125 | 142 |
| 1 | 2.5% SI-X, Mixed Amine (1) | H610 | 2.5 | Y | — | Y | Y | | | |
| 2 | 2.5% DETA, Mixed Amine (1) | H610 | 2.5 | N | | Y | Y | | | |
| 3 | 2.5% BHMT, Mixed Amine (1) | H610 | 2.5 | Y | — | Y | Y | | | |
| 4 | 2.5% SI-X, Mixed Amine (1) | ArivaSol | 2.5 | Y | — | Y | Y | | | |
| 5 | 2.5% DETA, Mixed Amine (1) | ArivaSol | 2.5 | Y | — | Y | Y | | | |
| 6 | 2.5% BHMT, Mixed Amine (1) | ArivaSol | 2.5 | Y | — | N | Y | | | |
| 7 | 2.5% SI-X, Mixed Amine (1) | TOFA | 2.5 | N | — | N | Y | | | |
| 8 | 2.5% DETA, Mixed Amine (1) | TOFA | 2.5 | N | — | N | Y | | | |
| 9 | 2.5% BHMT, Mixed Amine (1) | TOFA | 2.5 | N | — | N | Y | | | |
| 10 | 5% SI-X, 1:3 SI: 2-EHA, 2% 2-EhOH | ArivaSol | 2.5 | N | — | N | Y | | | |
| 11 | 5% SI-X, 1:3 SI: 2-EHA, 4% 2-EhOH | ArivaSol | 2.5 | N | — | N | Y | | | |
| 12 | 5% SI-X, 1:3 SI: 2-EHA, 8% 2-EhOH | ArivaSol | 2.5 | N | Y | Y | Y | — | Y | Y |
| 13 | 5% SI-X, 1:4 SI: 2-EHA, 2% 2-EhOH | ArivaSol | 2.5 | N | — | N | Y | | | |
| 14 | 5% SI-X, 1:4 SI: 2-EHA, 4% 2-EhOH | ArivaSol | 2.5 | N | — | N | Y | | | |
| 15 | 5% SI-X, 1:4 SI: 2-EHA, 8% 2-EhOH | ArivaSol | 2.5 | N | Y | Y | Y | — | Y | Y |
| 16 | 5% SI-X, 1:5 SI: 2-EHA, 2% 2-EhOH | ArivaSol | 2.5 | N | — | N | Y | | | |
| 17 | 5% SI-X, 1:5 SI: 2-EHA, 4% 2-EhOH | ArivaSol | 2.5 | N | — | N | Y | | | |
| 18 | 5% SI-X, 1:5 SI: 2-EHA, 8% 2-EhOH | ArivaSol | 2.5 | N | — | N | Y | | | |
| 19 | 5% DETA, 1:3 SI: 2-EHA, 2% 2-EhOH | ArivaSol | 2.5 | N | — | N | Y | | | |
| 20 | 5% DETA, 1:3 SI: 2-EHA, 4% 2-EhOH | ArivaSol | 2.5 | N | — | N | Y | | | |
| 21 | 5% DETA, 1:3 SI: 2-EHA, 8% 2-EhOH | ArivaSol | 2.5 | N | N | N | Y | | | |
| 22 | 5% DETA, 1:4 SI: 2-EHA, 2% 2-EhOH | ArivaSol | 2.5 | N | — | N | Y | | | |
| 23 | 5% DETA, 1:4 SI: 2-EHA, 4% 2-EhOH | ArivaSol | 2.5 | N | — | N | Y | | | |
| 24 | 5% DETA, 1:4 SI: 2-EHA, 8% 2-EhOH | ArivaSol | 2.5 | N | N | N | Y | | | |
| 25 | 5% DETA, 1:5 SI: 2-EHA, 2% 2-EhOH | ArivaSol | 2.5 | N | — | N | Y | | | |
| 26 | 5% DETA, 1:5 SI: 2-EHA, 4% 2-EhOH | ArivaSol | 2.5 | N | — | N | Y | | | |
| 27 | 5% DETA, 1:5 SI: 2-EHA, 8% 2-EhOH | ArivaSol | 2.5 | N | N | N | Y | | | |
| 28 | 2.5% SI-X, 1:3 SI: 2-EHA, 8% 2-EhOH | ArivaSol | 2.5 | Y | — | Y | Y | — | Y | Y |
| 29 | 2.5% SI-X, 1:3 SI: 2-EHA, 8% MEG | ArivaSol | 2.5 | | | N | N | | | |
| 30 | 2.5% SI-X, 1:3 SI: 2-EHA, 8% Butyl | ArivaSol | 2.5 | N | N | Y | Y | | Y | Y |
| | Triglycol | | | | | | | | | |
| 31 | 2.5% SI-X, 1:3 SI: 2-EHA, 8% IPA | ArivaSol | 2.5 | Y | — | Y | Y | — | Y | Y |
| 32 | 2.5% SI-X, 1:3 SI: 2-EHA, 8% EGMBE | ArivaSol | 8.0 | Y | — | Y | Y | — | Y | Y |
| 33 | 2.5% SI-X, 1:4 SI: 2-EHA, 8% 2-EhOH | ArivaSol | 2.5 | N | N | Y | Y | — | Y | Y |
| 34 | 2.5% SI-X, 1:4 SI: 2-EHA, 8% MEG | ArivaSol | 2.5 | | | | N | | | |
| 35 | 2.5% SI-X, 1:4 SI: 2-EHA, 8% Butyl- | ArivaSol | 2.5 | N | N | Y | Y | — | Y | Y |
| | Triglycol | | | | | | | | | |
| 36 | 2.5% SI-X, 1:4 SI: 2-EHA, 8% IPA | ArivaSol | 2.5 | Y | — | Y | Y | — | Y | Y |
| 37 | 2.5% SI-X, 1:4 SI: 2-EHA, 8% EGMBE | ArivaSol | 8.0 | N | N | Y | Y | — | Y | Y |
| 38 | 5% BHMT, 1:1 SI: 2-EHA | ArivaSol | 2.5 | Y | — | Y | Y | — | Y | Y |
| 39 | 5% BHMT, 1:2 SI: 2-EHA | ArivaSol | 2.5 | Y | — | Y | Y | — | Y | Y |
| 40 | 2.5% DETA, 1:3 SI: 2-EHA, 8% EhOH | ArivaSol | 2.5 | N | Y | Y | Y | | | Y |
| 41 | 2.5% DETA, 1:3 SI: 2-EHA, 8% Butyl | ArivaSol | 2.5 | N | | Y | Y | | | |
| | Triglycol | | | | | | | | | |
| 42 | 2.5% DETA, 1:3 SI: 2-EHA, 8% IPA | ArivaSol | 2.5 | Y | — | Y | Y | — | Y | Y |
| 43 | 2.5% DETA, 1:3 SI: 2-EHA, 8% ArivaSol | 8.0 | N | Y | Y | Y | | | Y | |
| | EGMBE | | | | | | | | | |
| 44 | 2.5% DETA, 1:4 SI: 2-EHA, 8% 2- | ArivaSol | 2.5 | N | Y | Y | Y | | | |
| | EhOH | | | | | | | | | |
| 45 | 2.5% DETA, 1:4 SI: 2-EHA, 8% Butyl | ArivaSol | 2.5 | N | — | N | Y | | | |
| | Triglycol | | | | | | | | | |
| 46 | 2.5% DETA, 1:4 SI: 2-EHA, 8% IPA | ArivaSol | 2.5 | Y | Y | Y | Y | — | Y | Y |
| 47 | 2.5% DETA, 1:4 SI: 2-EHA, 8% | ArivaSol | 8.0 | N | Y | Y | Y | | | |
| | EGMBE | | | | | | | | | |
| 48 | 2.5% DETA, 1:5 SI: 2-EHA, 8% 2- | ArivaSol | 2.5 | N | N | Y | Y | | | |
| | EhOH | | | | | | | | | |
| 49 | 2.5% DETA, 1:5 SI: 2-EHA, 8% Butyl | ArivaSol | 2.5 | N | — | N | Y | | | |
| | Triglycol | | | | | | | | | |
| 50 | 2.5% DETA, 1:5 SI: 2-EHA, 8% IPA | ArivaSol | 2.5 | Y | Y | Y | Y | — | Y | Y |
| 51 | 2.5% DETA, 1:5 SI: 2-EHA, 8% | ArivaSol | 8.0 | N | Y | Y | Y | | | |
| | EGMBE | | | | | | | | | |
| 52 | 5% DETA, 1:3 SI: 2-EHA, 8% 2-EhOH | ArivaSol | 2.5 | N | N | Y | Y | | | |
| 53 | 5% DETA, 1:3 SI: 2-EHA, 8% Butyl | ArivaSol | 2.5 | N | — | N | Y | | | |
| | Triglycol | | | | | | | | | |
| 54 | 5% DETA, 1:3 SI: 2-EHA, 8% IPA | ArivaSol | 2.5 | Y | — | Y | Y | — | Y | Y |
| 55 | 5% DETA, 1:3 SI: 2-EHA, 8% EGMBE | ArivaSol | 8.0 | N | N | Y | Y | | | |
| 56 | 2.5% BHMT, 1:2 SI: 2-EHA, 8% IPA | ArivaSol | 2.5 | | | | N | | | |
| 57 | 2.5% BHMT, 1:3 SI: 2-EHA, 8% IPA | ArivaSol | 2.5 | | | | N | | | |
| 58 | 2.5% BHMT, 1:4 SI: 2-EHA, 8% IPA | ArivaSol | 2.5 | | | | N | | | |
| 59 | 2.5% BHMT, 1:2 SI: 2-EHA, 8% 2- | ArivaSol | 2.5 | Y | — | Y | Y | — | Y | Y |
| | EhOH | | | | | | | | | |
| 60 | 2.5% BHMT, 1:3 SI: 2-EHA, 8% 2- | ArivaSol | 2.5 | N | N | Y | Y | — | Y | Y |
| | EhOH | | | | | | | | | |
| 61 | 2.5% BHMT, 1:4 SI: 2-EHA, 8% 2- | ArivaSol | 2.5 | N | | Y | Y | — | Y | Y |
| | EhOH | | | | | | | | | |
| 62 | 2.5% SI-X, 1:3 SI: 2-EHA, 8% TEG | ArivaSol | 2.5 | Y | — | Y | Y | — | Y | Y |
| 63 | 2.5% DETA, 1:3 SI: 2-EHA, 8% TEG | ArivaSol | 2.5 | Y | — | Y | Y | — | Y | Y |
| 64 | 2.5% BHMT, 1:3 SI: 2-EHA, 8% TEG | ArivaSol | 2.5 | Y | — | Y | Y | — | Y | Y |
| 65 | 5% SI-X, 1:3 SI: 2-EHA, 8% TEG | ArivaSol | 2.5 | Y | — | Y | Y | — | Y | Y |
| 66 | 5% DETA, 1:3 SI: 2-EHA, 8% TEG | ArivaSol | 2.5 | Y | — | Y | Y | — | Y | Y |
| 67 | 5% BHMT, 1:3 SI: 2-EHA, 8% TEG | ArivaSol | 2.5 | Y | — | Y | Y | — | Y | Y |
| 68 | 5% SI-X, 1:3 SI: 2-EHA, 8% EGMBE | ArivaSol | 8.0 | N | Y | Y | Y | — | Y | Y |
| 69 | 2.5% BHMT, 1:3 SI: 2-EHA, 8% | ArivaSol | 8.0 | N | Y | Y | Y | — | Y | Y |
| | EGMBE | | | | | | | | | |
| 70 | 5% BHMT, 1:3 SI: 2-EHA, 8% EhOH | ArivaSol | 2.5 | N | Y | Y | Y | — | Y | Y |

Additional compatibility tests, such as oil soluble scale inhibitor to brine, were performed using the new environmentally friendly oil soluble scale inhibitor. High ratios of scale inhibitor to amine, namely 1:4 and 1:5, caused an increase in the water phase pH, which is believed to cause a reduction in the oil soluble scale inhibitor to brine compatibility due to the dependence of the scale inhibitor compatibility upon pH.

Compatibility tests with Primene® 81-R were performed with substitute solvents to determine if acceptable formulations could be obtained. The main variables investigated were the type of scale inhibitor, the type of solvent, and the ratio of scale inhibitor to amine, or Primeneg 81-R. The results are summarized in Table 8. Tall oil fatty acid (TOFA) was the only natural oil to form a stable product. The results for base oil, Biobase 130 and Biobase 150 were marginal; however, data for the remaining hydrocarbon derived or synthetic solvents show that a stable formulation was obtained with each scale inhibitor.

TABLE 8
SUBSTITUTE SOLVENTS.
2.5 wt/wt % SI. EGMBE = 2.5 wt/wt %. Amine = Primene ® 81-R.
Ambient temperature.

| | 1:2 SI: 81-R. | | | 1:3 SI: 81-R. | | |
|---|---|---|---|---|---|---|
| | 2.5% EGMBE | | | 2.5 EGMBE | | |
| Solvent | SI-X | C-2501 | C-2608 | SI-X | C-2501 | C-2608 |
| H610 | Y⁽¹⁾ | Y⁽¹⁾ | Y⁽¹⁾ | Y⁽²⁾ | Y⁽²⁾ | Y⁽²⁾ |
| ArivaSol | Y | Y | Y | Y | Y | Y |
| Exxsol D60 | | | | Y | Y | Y |
| Exxsol D80 | | | | Y | Y | Y |
| Exxate 700 | Y | Y | Y | Y | Y | Y |
| Solvesso 150 | | | | Y | Y | Y |
| Isopar L | | | | Y | Y | Y |
| D-limonene | Y | Y | Y | Y | Y | Y |
| Base Oil | Y | Y | Y | Y | Y | Y |
| Kerosene | Y | Y | Y | Y | Y | Y |
| Hydrosolve N-220 | | | | N | N | N |
| Bio-Base 130 | Y | Y | Y | Y | Y | Y |
| Bio-Base 150 | Y | Y | Y | Y | Y | Y |
| US TOFA | | | | Y | Y | Y |
| Sunflower Oil | | | | N | | N |
| Olive Oil | | | | N | | N |
| Rapeseed Oil | | | | N | | N |
| Groundnut Oil | | | | N | | N |
| Grapeseed Oil | | | | N | | N |
| Walnut Oil | | | | N | | N |
| Sesame Oil | | | | N | | N |
| Fish Oil | | | | N | | N |
| Butyl triglycol | | | | Y | N | N |

| | | | |
|---|---|---|---|
| Solvent | 90 | Solvent | 87.5 |
| EGMBE | 2.5 | EGMBE | 2.5 |
| 81-R | 5 | 81-R | 7.5 |
| SI | 2.5 | SI | 2.5 |
| TOTAL | 100.0 | TOTAL | 100.0 |

Based upon the results of the Primene® 81-R test in Table 8, further tests were performed in which a second solvent was added to the natural oils to obtain a stable formulation. The results of these tests are shown in Tables 9 and 10. These tests were performed using 2.5 wt/wt % scale inhibitor, 1:3 scale inhibitor to amine ratio, and 2.5 wt/wt % EGMBE. ArivaSol® appeared to be a more effective second solvent compared to H610. Of the natural oils, olive oil, walnut oil, and sesame oil required less than 25% ArivaSol® to create a stable formulation. Sunflower oil, rapeseed oil, and groundnut oil require 25-35% ArivaSol. Grapeseed oil and fish oil require greater than 35% ArivaSol®. Olive oil required greater than 25% and sesame oil required greater than 35% H610 to obtain a stable formulation. All other natural oils required 42 -50% H610 to create a stable product.

TABLE 9
Mixtures of Natural Oils with H610. SI-X = 2.5 wt/wt %.
EGMBE = 2.5 wt/wt %. Amine = 81-R. Ambient temperature.

| | wt/wt % H610 | | | | | | |
|---|---|---|---|---|---|---|---|
| Solvent B | 0% | 10% | 25% | 30% | 35% | 42% | 50% |
| US TOFA | Y | Y | | | | | |
| Sunflower Oil | N | N | | | N | N | Y |
| Olive Oil | N | N | N | Y | Y | Y | Y |
| Rapeseed Oil | N | N | | | N | N | Y |
| Groundnut Oil | N | N | | | N | N | Y |
| Grapeseed Oil | N | N | | | N | N | Y |
| Walnut Oil | N | N | | | N | N | Y |
| Sesame Oil | N | N | | | N | Y | Y |
| Fish Oil | N | N | | | N | N | Y |

| | | | | | | | |
|---|---|---|---|---|---|---|---|
| H610 | 0 | 10 | 25 | 30 | 35 | 42 | 50 |
| Solvent B | 87.5 | 77.5 | 62.5 | 57.5 | 52.5 | 45.5 | 37.5 |
| EGMBE | 2.5 | 2.5 | 2.5 | 2.5 | 2.5 | 2.5 | 2.5 |
| 81-R | 7.5 | 7.5 | 7.5 | 7.5 | 7.5 | 7.5 | 7.5 |
| SI (SI-X) | 2.5 | 2.5 | 2.5 | 2.5 | 2.5 | 2.5 | 2.5 |
| Total | 100.0 | 100.0 | 100.0 | 100.0 | 100.0 | 100.0 | 100.0 |

TABLE 10
Mixtures of Natural Oils with ArivaSol.
SI-X = 2.5 wt/wt %. EGMBE = 2.5 wt/wt %. Amine = 81-R.
Ambient temperature.
wt/wt % ArivaSol

| Solvent B | 0% | 10% | 25% | 30% | 35% | 42% | 50% |
|---|---|---|---|---|---|---|---|
| US TOFA | Y | Y | | | | | |
| Sunflower Oil | N | N | N | Y | Y | | Y |
| Olive Oil | N | Y | Y | Y | Y | | Y |
| Rapeseed Oil | N | N | N | Y | Y | | Y |
| Groundnut Oil | N | N | N | Y | Y | | Y |
| Grapeseed Oil | N | | | | N | Y | Y |
| Walnut Oil | N | N | Y | Y | Y | Y | |
| Sesame Oil | N | N | Y | Y | Y | | Y |
| Fish Oil | N | | | | N | Y | Y |

| | | | | | | | |
|---|---|---|---|---|---|---|---|
| ArivaSol | 0 | 10 | 25 | 30 | 35 | 42 | 50 |
| Solvent B | 87.5 | 77.5 | 62.5 | 57.5 | 52.5 | 45.5 | 37.5 |
| EGMBE | 2.5 | 2.5 | 2.5 | 2.5 | 2.5 | 2.5 | 2.5 |
| 81-R | 7.5 | 7.5 | 7.5 | 7.5 | 7.5 | 7.5 | 7.5 |
| SI (SI-X) | 2.5 | 2.5 | 2.5 | 2.5 | 2.5 | 2.5 | 2.5 |
| Total | 100.0 | 100.0 | 100.0 | 100.0 | 100.0 | 100.0 | 100.0 |

The compatibility of 2-EHA with substitute solvents was also investigated. The main variables studied were the type of scale inhibitor, the ratio of scale inhibitor to 2-EHA, and the type of solvent. The EGMBE concentration was 2.5 wt/wt % in each case. The results are summarized in Table 11. 2-EHA seems to be a poorer component in terms of formulation compatibility than Primene® 81-R, but the environmental rating is significantly better.

TABLE 11
Substitute Solvents with 2-EHA.
SI = 2.5 wt/wt %. EGMBE = 2.5 wt/wt %. Amine 2-EHA. Ambient temperature.

| | 1:1 SI:2-EHA | | | 1:2 SI:2-EHA | | | 1:3 SI:2-EHA | | | 1:4 SI:2-EHA | | | 1:5 SI:2-EHA | | |
|---|---|---|---|---|---|---|---|---|---|---|---|---|---|---|---|
| | | C- | C- | | C- | C- | | C- | C- | | C- | C- | | C- | C- |
| Solvent | SI-X | 2501 | 2608 | SI-X | 2501 | 2608 | SI-X | 2501 | 2608 | SI-X | 2501 | 2608 | SI-X | 2501 | 2608 |
| H6 10 | N | | Y | N | Y | Y | N | Y | Y | N | Y | Y | N | Y | Y |
| ArivaSol | N | Y | Y | N | Y | Y | N | Y | Y | Y | Y⁽¹⁾ | Y | Y | Y⁽¹⁾ | Y |
| Exxsol D60 | | | N | | | Y⁽¹⁾ | N | | Y | N | | Y | | | Y |
| Exxsol D80 | | | N | | | Y⁽¹⁾ | N | | N | N | | N | | | N |
| Exxate 700 | | | Y⁽¹⁾ | N | Y | Y | N | N | N | N | | N | | | N |
| Solvesso 150 | | | N | | | Y⁽¹⁾ | N | | Y | N | | Y | | | Y |
| Isopar L | | | N | | | Y⁽¹⁾ | N | | Y | N | | N | | | N |
| D-limonene | | | Y | N | Y | Y | N | Y | Y | N | | N | | | N |
| Base Oil | N | | Y | N | N | Y | N | N | Y | N | Y | Y | N | Y | N |
| Kerosene | | | N | N | N | Y | N | N | N | N | | Y | | | N |
| Hydrosolve N-220 | | | N | | | N | N | N | N | | | N | | | N |
| Bio-Base 130 | | | N | N | N | N | N | N | N | | N | | | N | |
| Bio-Base 150 | | | N | N | | N | N | N | N | N | | N | | | N |
| US TOFA | | | N | | | Y | Y | | Y | Y | | Y | | | Y |
| Sunflower Oil | | | | | | | | | N | | | N | | | N |
| Olive Oil | | | | | | | | | N | | | N | | | N |
| Rapeseed Oil | | | | | | | | | N | | | N | | | N |
| Groundnut Oil | | | | | | | | | N | | | N | | | N |
| Grapeseed Oil | | | | | | | | | N | | | N | | | N |
| Walnut Oil | | | | | | | | | N | | | N | | | N |
| Sesame Oil | | | | | | | | | N | | | N | | | N |
| Fish Oil | | | | | | | | | N | | | N | | | N |
| Butyl triglycol | | | | Y | N | N | Y | N | N | Y | N | N | | | |

| | | | | | | | | | |
|---|---|---|---|---|---|---|---|---|---|
| Solvent | 92.5 | Solvent | 90 | Solvent | 87.5 | Solvent | 85 | Solvent | 82.5 |
| EGMBE | 2.5 | EGMBE | 2.5 | EGMBE | 2.5 | EGMBE | 2.5 | EGMBE | 2.5 |
| 2-EHA | 2.5 | 2-EHA | 5 | 2-EHA | 7.5 | 2-EHA | 10 | 2-EHA | 12.5 |
| SI | 2.5 | SI | 2.5 | SI | 2.5 | SI | 2.5 | SI | 2.5 |
| Total | 100.0 | Total | 100.0 | Total | 100.0 | Total | 100.0 | Total | 100.0 |

⁽¹⁾Precipitate on first mixing. Reduced after standing or re-mixing.

Compatibility tests were also conducted with a mixture of amines. The tests were conducted with 1 part 2-EHA and 2 parts Primene® 81-R with various solvents. The results of the tests are shown in Table 12. Adding Primene® 81-R to 2-EHA increased the stability of several formulations when compared to the same, but with only 2-EHA.

TABLE 12
2.5 wt/wt % SI. Amine = 1:2 Mix 2-EHA: Primene ® 81-R
Ambient temperature.

| | 1:3 SI: Total Amine | | |
|---|---|---|---|
| Solvent | SI-X | C-2501 | C-2608 |
| H610 | Y | Y | Y |
| ArivaSol | Y | Y | Y |
| Exxsol D60 | Y | Y | Y |
| Exxsol D80 | N | N | N |
| Exxate 700 | Y | Y | Y |
| Solvesso 150 | Y | Y | Y |
| Isopar L | N | Y | Y |
| D-limonene | Y | Y | Y |
| Base Oil | N | Y⁽⁴⁾ | Y |
| Kerosene | N | Y⁽⁴⁾ | Y |
| Hydrosolve N-220 | N | N | N |
| Bio-Base 130 | N | Y⁽⁴⁾ | Y |
| Bio-Base 150 | N | Y⁽⁴⁾ | Y |
| US TOFA | Y | Y | Y |
| Sunflower Oil | | | N |
| Olive Oil | | | N |
| Rapeseed Oil | | | N |
| Groundnut Oil | | | N |
| Grapeseed Oil | | | N |
| Walnut Oil | | | N |
| Sesame Oil | | | N |
| Fish Oil | | | N |

| | |
|---|---|
| Solvent | 87.5 |
| EGMBE | 2.5 |
| 2-EHA | 2.5 |
| Primene ® 81-R | 5 |
| SI | 2.5 |
| Total | 100.0 |

### Example 8

### Temperature Stability

Low temperature stability was tested for various formulations. Four low temperature stations (−20° C., −7° C., +4° C., and 20° C.) and three high temperature stations (88° C., 125° C., 142° C.) were utilized during these tests. Subambient tests were performed for seven days to simulate winter manufacture or offshore storage and handling. Product stability at −7° C. for seven days was identified as a minimum criteria for further evaluation of any of the formulations. Tests at elevated temperatures were performed for 24 hours only and were not agitated during inspection as a safety precaution.

During the temperature stability tests, the type of scale inhibitor, scale inhibitor concentration, scale inhibitor to amine ratio, additive concentration (2-8%), and temperature were varied. The additives that were investigated included 2-ethyl hexanol, monoethylene glycol, butyl triglycol, isopropyl alcohol, EGMBE, and triethylene glycol. The results from these tests are shown in Table 7, which is shown above, with the formulations given in Appendix 2. Formulations using the mixed amine were stable down to −20° C. and could be prepared with various solvents. Based upon the results, 2-EHA formulations were less stable than Primeneg formulations at lower temperatures. Additives such as IPA, TEG, and EGMBE also increased the low temperature stability. However, TEG formed a precipitate when the constituents were added in the normal order, but dispersed after standing overnight and further mixing.

### Example 10

Coreflood Tests

Coreflood tests were conducted on two formulations of the environmentally friendly version of the oil-soluble scale inhibitor. The first formulation, OSi EXP1, contained 70 wt. % ArivaSol, 15 wt. % 2-EHA, 10 wt. % EGMBE, and 5 wt. % DETA. The second formulation, OSi EXP2, contained 70 wt. % ArivaSol, 15 wt. % 2-EHA, 10 wt. % EGMBE, and 5 wt. % SI-X. The calculations and data used to obtain the ambient core permeability to kerosene, and initial and final effective permeabilities to crude oil are presented in Table 13. The data show an initial effective permeability to oil of 350 mD and a final value of 443 mD. The % return oil permeability is calculated from these data to be about 126%, which is consistent with tests of this nature.

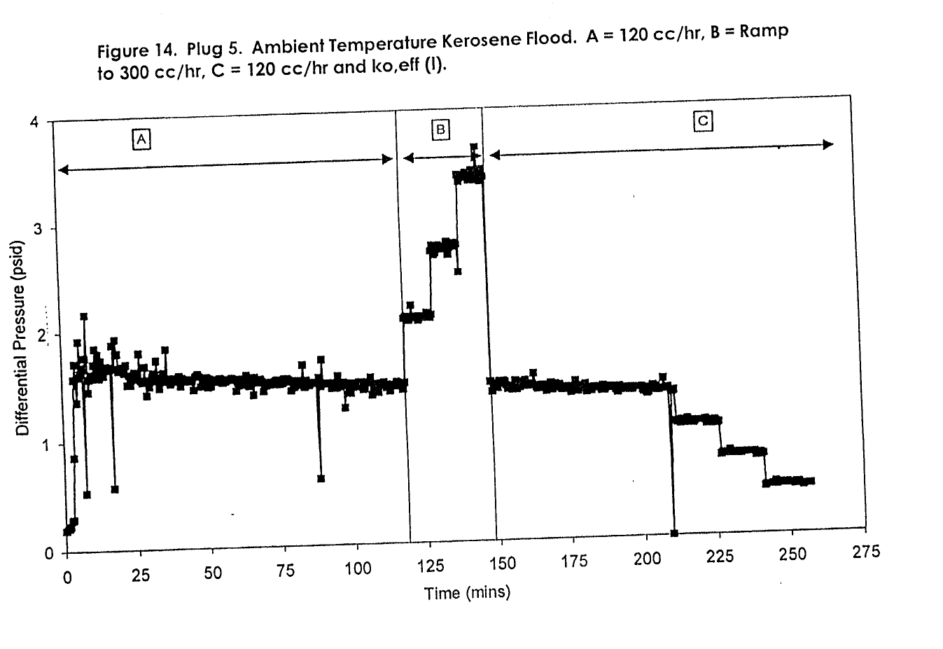

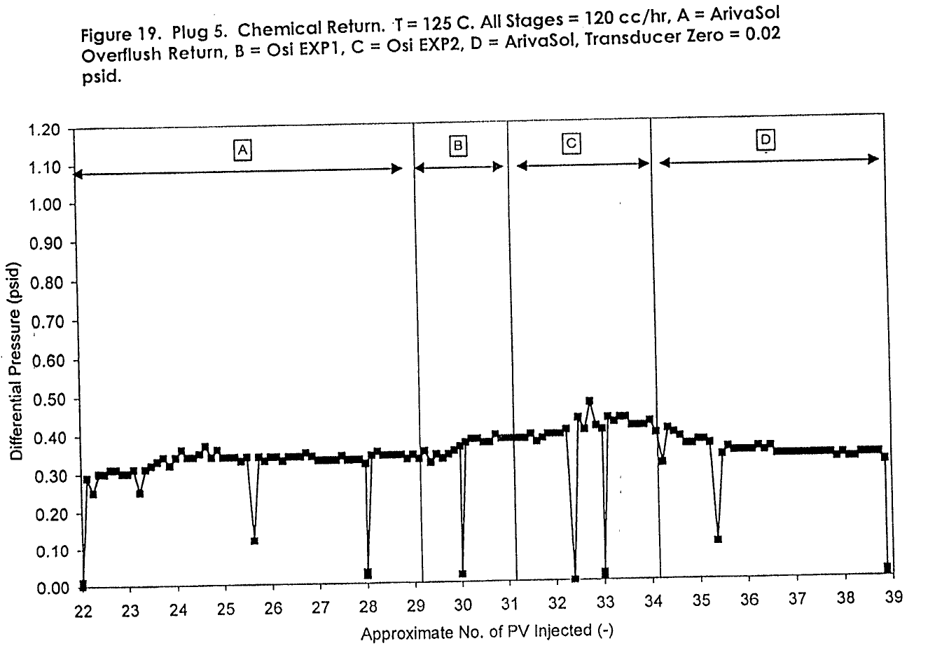

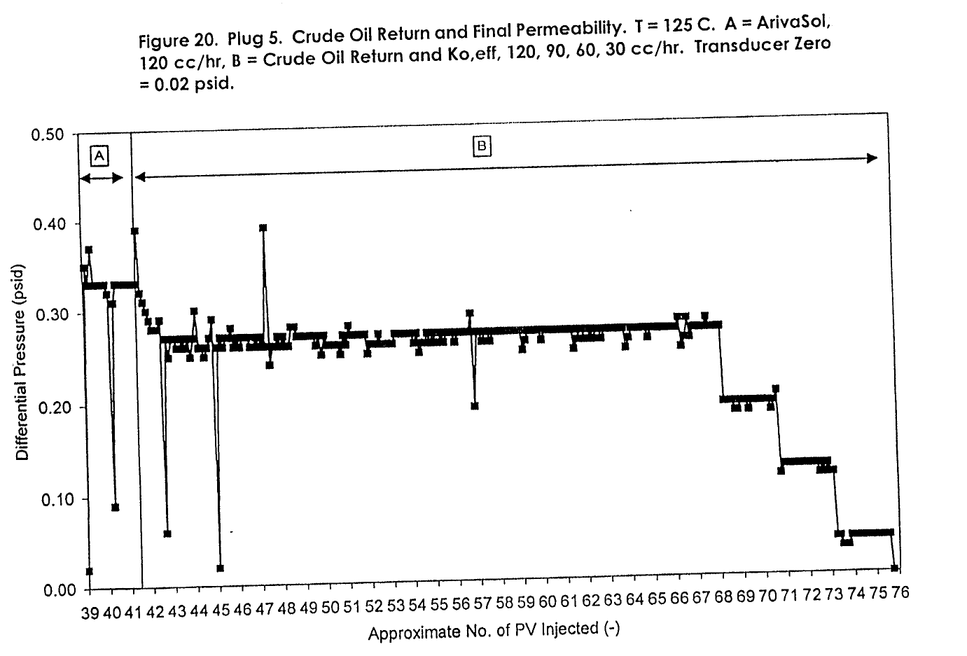

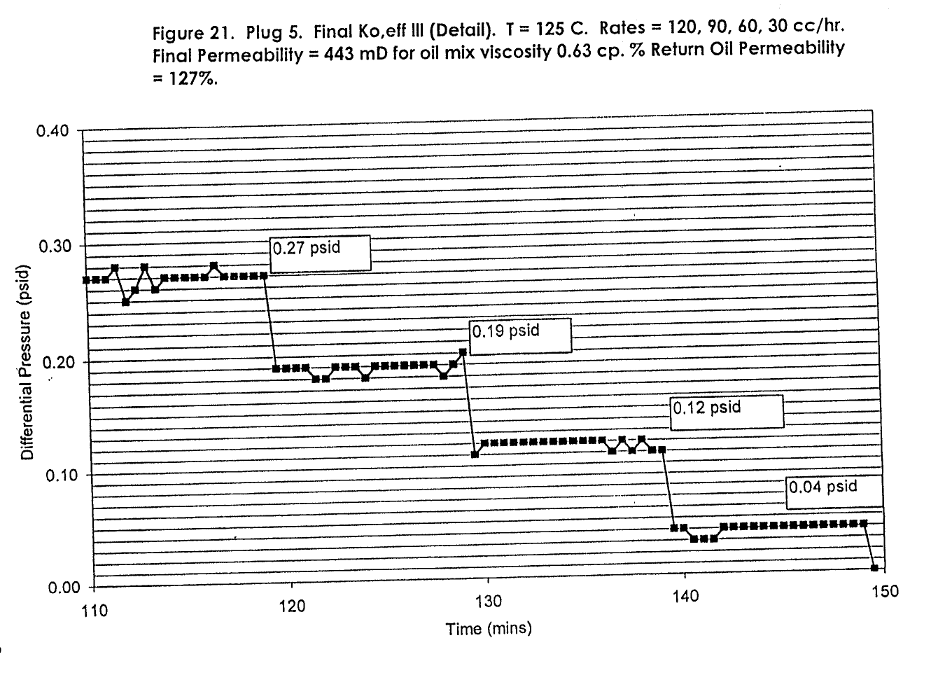

Data showing the measured core differential pressure (ΔP) versus time or approximate number of pore volume injected for each test stage are presented as FIGS. 14 through 22

[image]

FIG. 14 shows the ambient temperature kerosene flood. At approximately two hours, the injection rate was increased stepwise to a maximum of 300 cc/hr to ensure a reliable base-line reading. Upon returning to 120 cc/hr, the ΔP returned to a similar value to that observed prior to the ramp, suggesting that no mobile water was present. The final portion of FIG. 1 shows the measurement of the effective permeability to kerosene [ko,eff(I)] by decreasing rate method.

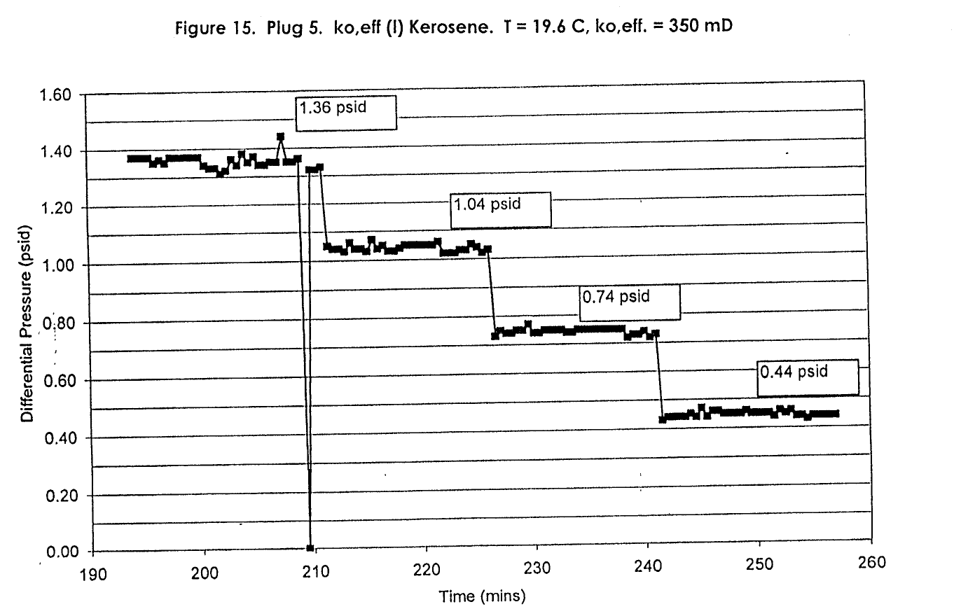

FIG. 15 shows detail of the ambient temperature decreasing rate permeability measurement to kerosene. The values of sample ΔP at each injection rate are used to calculate the effective permeability to kerosene [ko,eff(I)].

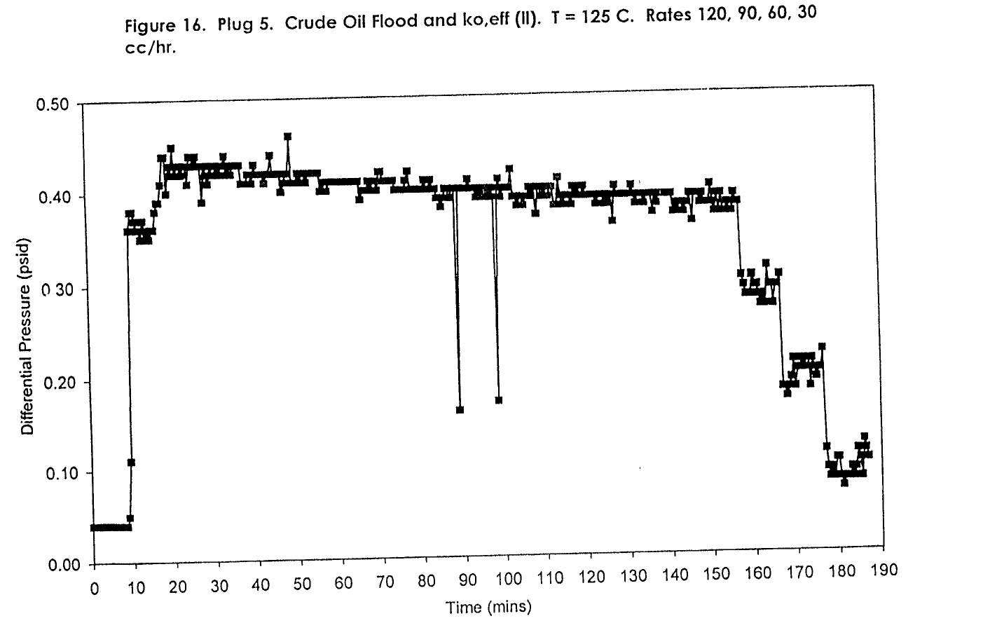

FIG. 16 shows the crude oil flood and measurement of effective permeability to crude oil [ko,eff(II)] at 125° C. A slight downward trend was observed over the duration of the stage, which was approximately three hours. However, this was not significant in relation to the final permeability value obtained.

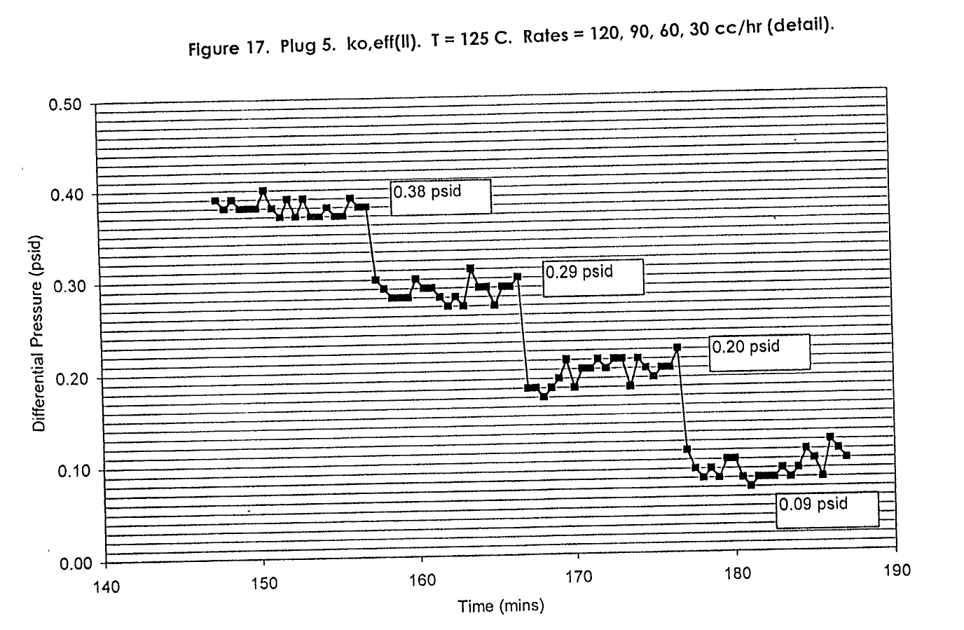

FIG. 17 shows detail of the measurement of effective permeability to crude oil [ko,eff (II)]. The values of sample ΔP at each injection rate are used to calculate the initial permeability as before.

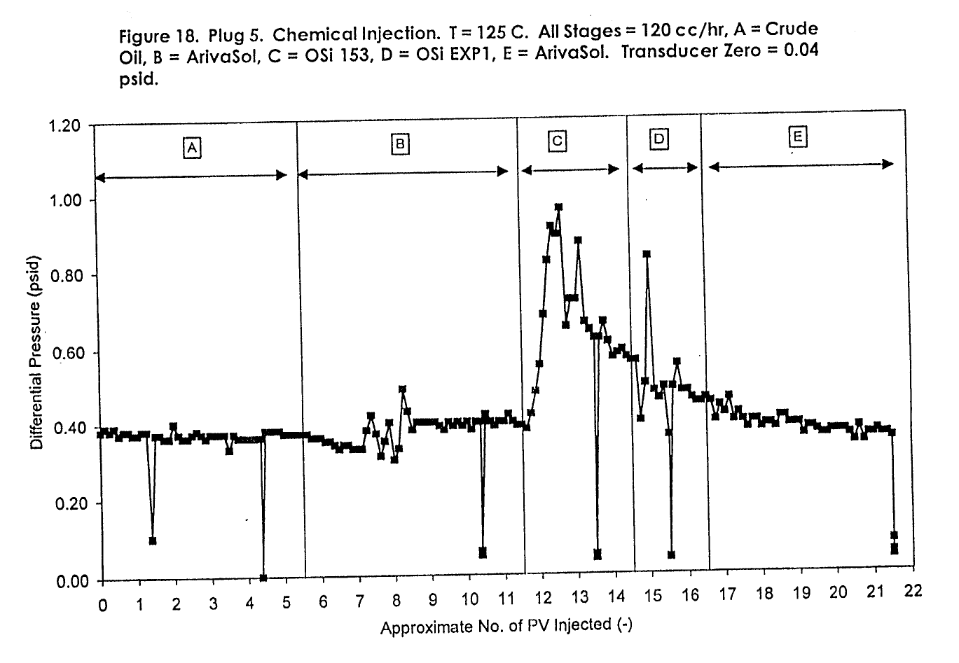

FIG. 18 shows the ΔP for each of the OSi injection stages. All stages were performed at 120 cc/hr. Stage A shows injection of crude oil to obtain a stable base-line. Stage B shows injection of the solvent spearhead. Stage C shows injection of the OSi pre-flush (OSi EXP2). During stage C, the value of flowing ΔP is found to increase by a factor of 2.5 compared to the value for crude oil. Values of increase of less than ˜5 are not believed likely to cause significant injectivity problems. The ΔP is shown to decrease again during stages D and E. It is noted that the increase in ΔP is more normally observed to be greater for the main-pill (stage D) than for the pre-flush (stage C). The reason why this is not observed in this case is not known.

Digital images of samples collected during the main effluent stages are presented as FIGS. A1 to A9. No adverse features are seen although it was noted that small portions of oil were produced for some time during the SFW waterflood stage. This may be due to several factors including the oil: water viscosity ratio and plug wettability and does not necessarily imply any influence of the OSi.

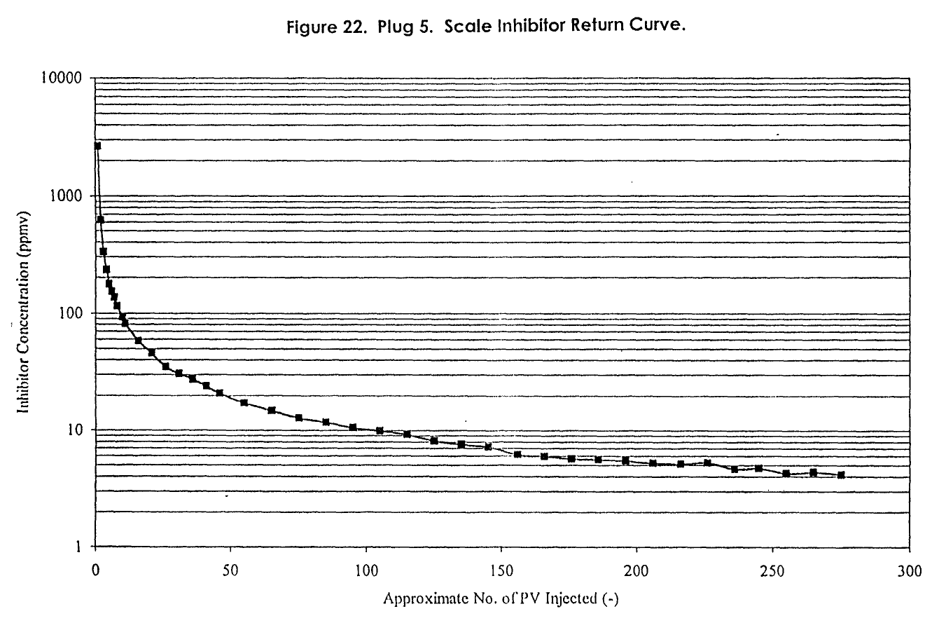

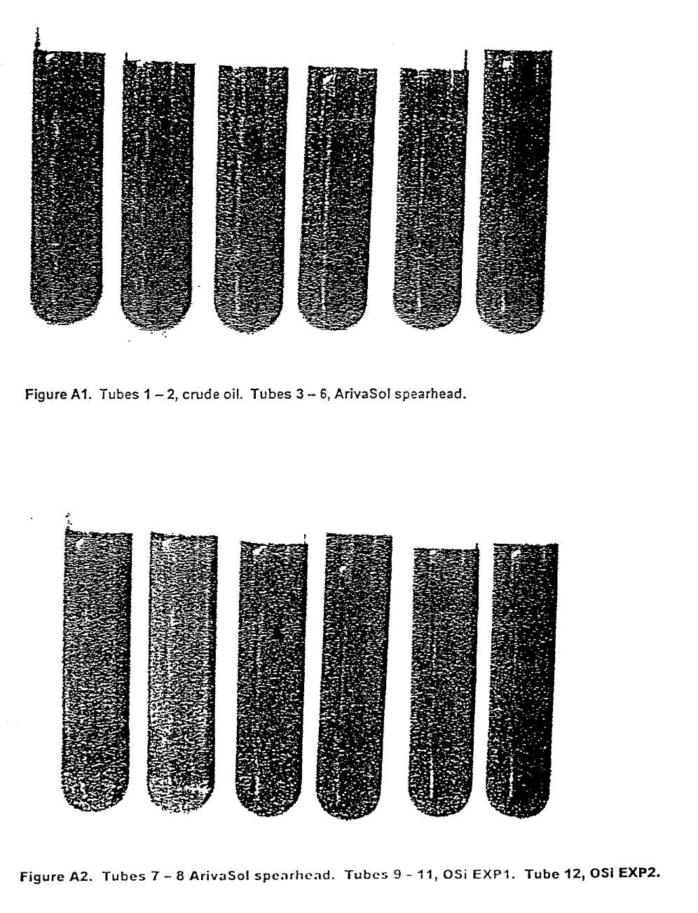

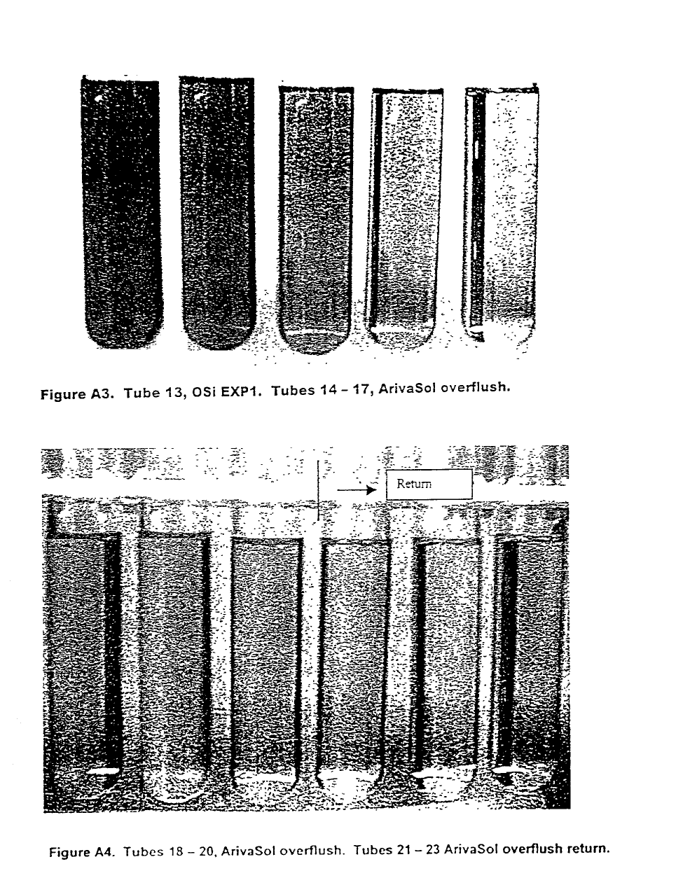

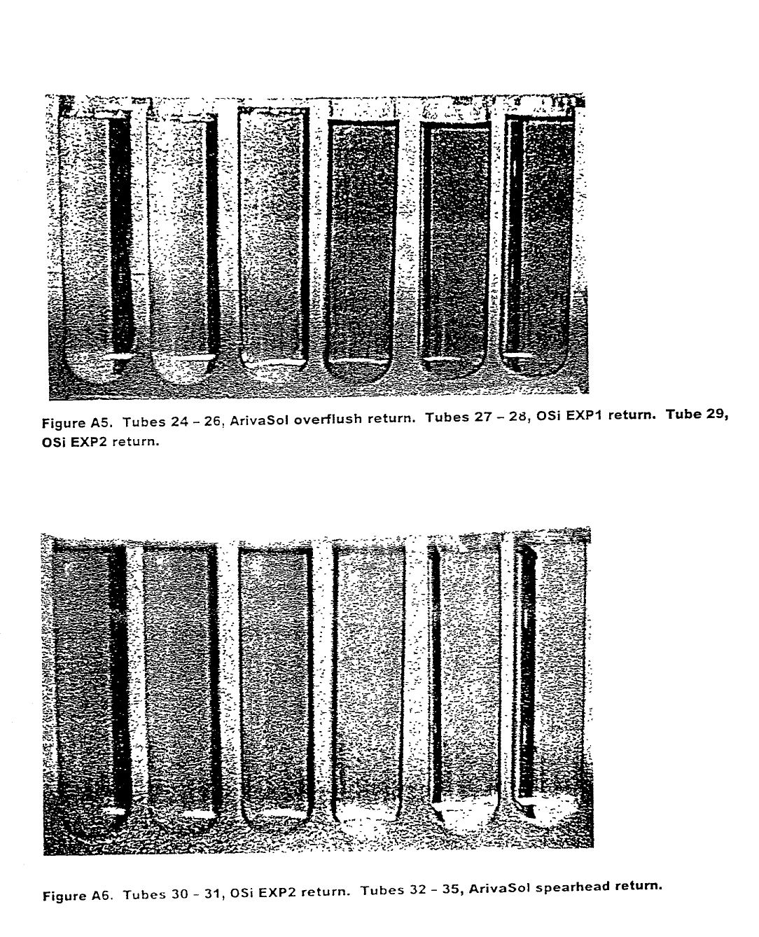

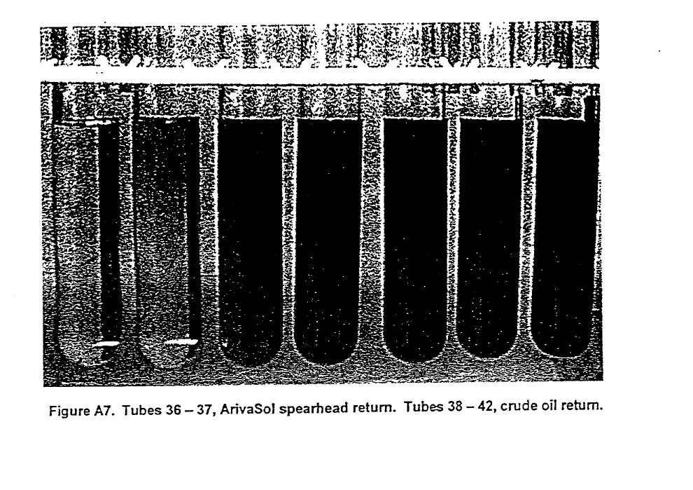

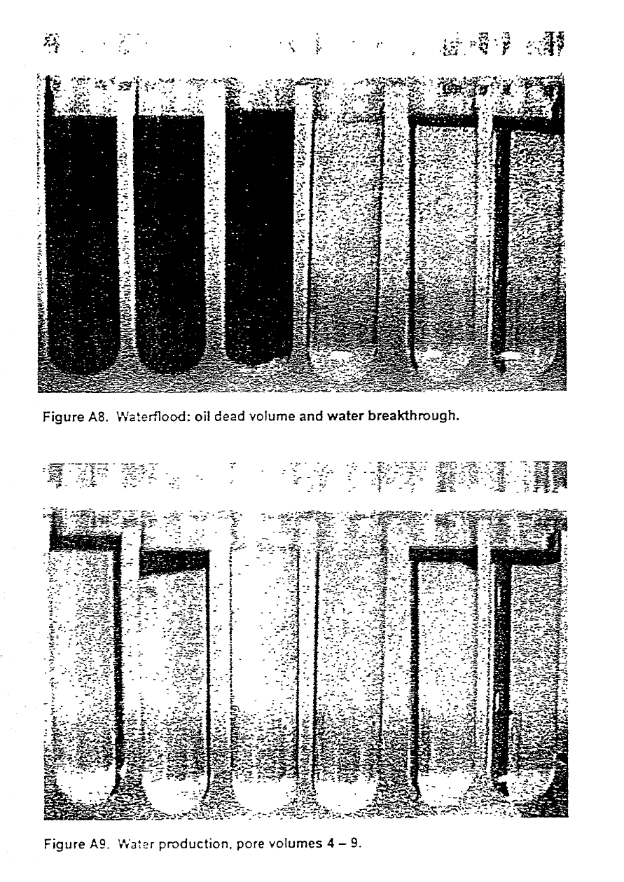

Data showing the scale inhibitor return concentration versus approximate PV injected are presented as FIG. 22. Assuming a value for the minimum inhibitor concentration (MIC) of ˜5 ppm, the data fall below the MIC after ˜225 PV injected.

The data presented as FIG. 22 have not been corrected to account for the actual plug PV or the plug residual oil saturation (Sro). Correction for Sro will reduce the effective PV occupied by water, thereby extending the curve slightly relative to the X axis. The PV number at which the curve crosses the MIC value will also be increased.

OSi EXP2 and EXP1 were selected to be used in this first test because they represent the most environmentally friendly products of the present development series and because the active scale inhibitor components are the same as those present in OSi EXP2(81R) and EXP1(81R), both tested and used previously.

The coreflood tests using OSi EXP2(81R) and EXP1(81R) used plug samples having an initial effective permeability to oil of ˜100 mD and gave % return oil permeabilities in the range 73-88%. Maximum increases in ΔP of ˜3 times the flowing ΔP to crude oil were also observed. The values obtained in the present coreflood tests compare favorably to these data although it is noted that the permeability of the samples used in the earlier tests may present a slightly more difficult test.

A coreflood of OSi EXP1/EXP2 products has been performed using Texaco Galley core and crude oil. The data show satisfactory performance during both the chemical injection and return stages with a final % return oil permeability of 126%. These data compare favorably with earlier work performed for Galley using established OSi products EXP2(81R) and EXP1(81R).

From the foregoing it will be seen that this invention is one well adapted to attain all of the ends and objects hereinabove set forth, together with other advantages which are obvious and which are inherent to the method and product.

It will be understood that certain features and subcombinations are of utility and may be employed without reference to other features and subcombinations. This is contemplated by and is within the scope of the claims.

Because many possible embodiments may be made of the invention without departing from the scope thereof, it is to be understood that all matter herein set forth or shown in the accompanying specification is to be interpreted as illustrative and not in a limiting sense.

We claim:

1. A composition comprising an oil-soluble scale inhibitor in a solvent, said oil-soluble scale inhibitor comprising a scale inhibitor and an alkyl primary amine.

2. The composition of claim 1 wherein the alkyl primary amine is selected from the group consisting of a primary alkyl primary amine, a secondary alkyl primary amine, a tertiary alkyl primary amine, and mixtures thereof.

3. The composition of claim 1 wherein the alkyl primary amine has a concentration in a range of about 2.5 wt. % to about 25 wt. %.

4. The composition of claim 1 wherein the solvent is selected from the group consisting of esters, aromatic hydrocarbons, aliphatic cycloparaffinic hydrocarbons, paraffin hydrocarbons and low aromatic distillates, terpenes, linear and alpha olefins, fatty acids, natural oils, and mixtures thereof.

5. The composition of claim 1 wherein the solvent is selected from the group consisting of 2-ethyl hexanol, butyl triglycol, isopropanol, triethylene glycol, and 2-butoxyethanol.

6. The composition of claim 2, wherein the alkyl primary amine is 2-ethylhexyl amine.

7. The composition of claim 1 wherein the scale inhibitor comprises phosphonic acids.

8. The composition of claim 7 wherein the scale inhibitor has a concentration in a range of about 1 wt. % to about 30 wt. %.

9. The composition of claim 8, wherein the scale inhibitor has a concentration preferably in a range of about 2.5 wt. % to about 5 wt. %.

10. The composition of claim 2 wherein the primary alkyl primary amine contains six or more carbon atoms.

11. The composition of claim 1 further comprising an additive selected from the group consisting of formic acid, acetic acid, 2 ethyl hexanol, monoethylene glycol, butyl triglycol, isopropyl alcohol, triethylene glycol, and 2-butoxyethanol.

12. The composition of claim 11 wherein the additive has a concentration in a range of about 2.5 wt. % to about 8 wt. %.

13. The composition of claim 1 wherein the proportions of alkyl primary amine to scale inhibitor are between the ratios 5:1 and 1:1.

14. A method of treating a producing oil well susceptible to scale formation comprising the steps of injecting into the well an oil soluble scale inhibitor where the inhibitor comprises a scale inhibitor and an alkyl primary amine.

15. The method of claim 14 wherein the alkyl primary amine is selected from the group consisting of a primary alkyl primary amine, a secondary alkyl primary amine, a tertiary alkyl primary amine, and mixtures thereof.

16. The method of claim 14 wherein the alkyl primary amine has a concentration in a range of about 2.5 wt. % to about 25 wt. %.

17. The method of claim 15 wherein the alkyl primary amine is 2-ethylhexyl amine.

18. The method of claim 14 further comprising the step of introducing the oil soluble scale inhibitor into a solvent wherein the solvent is selected from the group consisting of esters, aromatic hydrocarbons, aliphatic cycloparaffinic hydrocarbons, paraffin hydrocarbons and low aromatic distillates, terpenes, linear and alpha olefins, fatty acids, natural oils, and mixtures thereof.

19. The method of claim 14 wherein said scale inhibitor comprises phosphonic acids.

20. The composition of claim 19 wherein the scale inhibitor has a concentration in a range of about 1 wt. % to about 30 wt. %.

21. The composition of claim 20, wherein the scale inhibitor has a concentration preferably in the range of about 2.5 wt. % to about 5 wt. %.

22. The method of claim 21 wherein the solvent is selected from the group consisting of 2-ethyl hexanol, butyl triglycol, isopropanol, triethylene glycol, and 2-butoxyethanol.

23. The method of claim 14 further comprising the step of injecting the oil soluble scale inhibitor in conjunction with the step of injecting other additives selected from the group consisting of formic acid, acetic acid, 2 ethyl hexanol, monoethylene glycol, butyl triglycol, isopropyl alcohol, triethylene glycol, and 2-butoxyethanol.

24. The method of claim 23 wherein the additive has a concentration in a range of about 2.5 wt. % to about 8 wt. %.

25. The method of claim 14 wherein the alkyl primary amine in proportion to the scale inhibitor is between a ratio of about 5:1 to about 1:1 when the oil soluble scale inhibitor is injected into the well.

26. A method of treating a well comprising the step of injecting an oil soluble scale inhibitor into an oil system having a flow of oil or gas to deliver the inhibitor to water based scale.
